(19) United States
(12) Patent Application Publication
(10) Pub. No.: US 2026/0365219 A1
(43) Pub. Date: Nov. 19, 2026

(54) MODULAR STROLLER

(71) Applicant: Samara Brands, LLC, Charlotte, NC (US)

(72) Inventors: Stephon Wilkerson, Greensboro, NC (US); Eboni Wilkerson, Greensboro, NC (US)

(21) Appl. No.: 19/749,918

(22) Filed: Jul. 22, 2026

Related U.S. Application Data
(63) Continuation-in-part of application No. 19/170,161, filed on Apr. 4, 2025.
(60) Provisional application No. 63/574,941, filed on Apr. 5, 2024.

(51) Int. Cl. B62B 7/08; B62B 7/14; B62B 9/20

(52) U.S. Cl. CPC B62B 7/08; B62B 7/14; B62B 9/20; B62B 2205/24; B62B 2301/046

(57) ABSTRACT

A modular stroller system includes a base assembly with a central block assembly and two lateral sub-blocks that pivot inward toward each other in a book-fold arrangement. A folding mechanism within the central block assembly governs locking and release of the lateral sub-blocks between deployed and folded positions. A retractable auxiliary handle, stored within the central block assembly, is designed for initiating the folding sequence. Frame anchoring elements mounted on the base assembly fold independently between deployed and stowed positions to provide attachment points for an infant car seat. A multi-articulated main handle assembly includes a hinge joint for folding in half and a telescopic adjustment unit for reach regulation. A handle-to-rear-leg synchronization assembly kinematically links folding of the main handle assembly to retraction of a rear wheel strut, enabling coordinated compaction of the stroller system for transport or storage.

### CROSS-REFERENCE TO RELATED APPLICATIONS

This application is a continuation-in-part application of U.S. Patent Application No. 19/170,161, filed on Apr. 4, 2025, which claims the benefit and priority to U.S. Provisional Patent Application No. 63/574,491, filed on Apr. 5, 2024, the contents of which are herein incorporated by reference in their entirety.

### BACKGROUND

Traveling with infants and young children is difficult. Parents have to transport the infant, a stroller, a carrying apparatus, a seat, and various supplies for taking care of the infant (e.g., diaper bag). This is particularly troublesome when traveling via airplanes and similar types of transportation. Parents must transport their children, check in the stroller, carry a supplies bag, and their own luggage. Further, when leaving the airport, it can be difficult to find a vehicle that fits all of the luggage and supports the car seat. Therefore, there is a need for a modular stroller that reduces a parent’s burden when traveling with an infant/child.

### FIELD OF THE DISCLOSURE

The present disclosure is generally related to modular strollers, more specifically to modular strollers that convert to a storage apparatus to improve traveling.

### DESCRIPTION OF RELATED ART

Existing strollers include collapsible strollers and strollers with removable seats. However, existing strollers fail to provide a modular solution that enables a stroller to reduce into a compact size to lower a traveler’s burden. These existing strollers provide adjustable components, but do not provide a comprehensive product that is operable to sufficiently reduce its size. Therefore, there is a need for a modular stroller that provides an all-in-one solution for improving travel with infants and children.

### BRIEF SUMMARY

Aspects of the present disclosure address the burden on parents traveling with infants and young children by providing a modular stroller system that transforms between deployed and compact configurations for improved portability and storage.

In accordance with one aspect, a modular stroller system is provided. The modular stroller system comprises a base assembly comprising a central block assembly and two lateral sub-blocks. The two lateral sub-blocks may be pivotably connected to the central block assembly and are configured to fold inward toward each other about the central block assembly when the base assembly transitions between a deployed configuration to a folded configuration. A folding mechanism is disposed within the central block assembly. The folding mechanism is configured to selectively lock the lateral sub-blocks in the deployed configuration and to release the lateral sub-blocks to permit folding. An auxiliary handle is operatively coupled to the folding mechanism to transition the base assembly between the deployed configuration and the folded configuration. A main handle assembly is pivotably connected to the base assembly. A front wheel assembly and a rear wheel assembly are connected to the base assembly. At least one frame anchoring element is mounted on the base assembly. The at least one frame anchoring element may be independently foldable between a deployed position and a folded position. In the deployed position, the at least one frame anchoring element is configured to provide an attachment point for an infant car seat.

According to various embodiments, a modular stroller system may include a base assembly, an auxiliary handle, a main handle assembly, a front wheel assembly, and a rear wheel assembly. The base assembly may include a central block assembly and two lateral sub-blocks pivotably connected to the central block assembly. The base assembly is configured to transition between a deployed configuration and a folded configuration. The auxiliary handle is operatively coupled to the base assembly to initiate transition between the deployed configuration and the folded configuration. The main handle assembly is pivotably connected to the base assembly and configured to fold. The front wheel assembly and the rear wheel assembly are connected to the base assembly. The central block assembly defines a hinge axis positioned between the lateral sub-blocks. The lateral sub-blocks are configured to pivot about the hinge axis into a closed-book configuration when moving from the deployed configuration to the folded configuration.

The modular stroller system further comprises a handle-to-rear-leg synchronization assembly configured to operatively couple folding of the main handle assembly with folding of a rear wheel strut of the rear wheel assembly. The rear wheel assembly comprises a rear wheel strut pivotably connected via a folding linkage, wherein the rear wheel strut is configured to retract into a compact position during folding. The lateral sub-blocks form a continuous planar support surface substantially parallel to a ground plane in the deployed position. The continuous planar support surface is configured to receive an infant car seat. The auxiliary handle is retractably stored within the central block assembly.

The main handle assembly comprises an angular and rotational adjustment component for a terminal handle section. The main handle assembly comprises at least two handle branches and at least two hinge joints, wherein the at least two hinge joints are configured to control spacing between the at least two handle branches when moving between the folded position and the deployed position. The main handle assembly comprises a hinge joint configured to allow the main handle assembly to fold in half. The main handle assembly comprises a telescopic adjustment unit for reach regulation. The front wheel assembly comprises a locking mechanism configured to prevent wheel swiveling when engaged.

The front and rear wheel assemblies are connected to the base assembly via tubular transition elements that transfer load between the central block assembly and the wheel assemblies. Each frame anchoring element is lockable in each of the deployed position and the folded position, providing attachment points for securing an infant car seat to the modular stroller system.

In some embodiments, the present disclosure includes a modular stroller designed to move between a backpack, a car seat configuration, and a stroller. The modular stroller is designed to fit inside the backpack. Advantageously, this provides effortless portability and storage when worn on the user's back.

In at least one aspect of the present disclosure, a modular stroller frame is disclosed. The modular stroller frame can include at least one support brace, a plurality of support members, a base, and a plurality of wheels. The at least one support brace can be adjustably connected to the plurality of support members. The modular stroller frame can move between a collapsed configuration and an open configuration. When moving from the collapsed configuration to the open configuration, the at least one support brace can move away from the plurality of support members.

In at least one aspect of the present disclosure, the at least one support brace is U-shaped. In at least one aspect of the present disclosure, the plurality of wheels can be adjustably connected to the plurality of support members. In at least one aspect of the present disclosure, the at least one support brace can be adjustably connected to the plurality of support members via at least one adjustable component. The support brace can slide along a track of the adjustable component. In at least one aspect of the present disclosure, the at least one support brace can include at least one extension component. The at least one extension component can adjust a position of the at least one support brace. In at least one aspect of the present disclosure, each support member of the plurality of support members can receive an attachment component corresponding to the base. In at least one aspect of the present disclosure, the base can releasably engage a seat.

In at least one aspect of the present disclosure, a modular stroller frame is disclosed. The modular stroller frame can include at least one support brace, a plurality of support members, a base, and a plurality of wheels. The at least one support brace can be adjustably connected to the plurality of support members. The base can be adjustably connected to the plurality of support members. The modular stroller frame can move between a collapsed configuration and an open configuration. When moving from the collapsed configuration to the open configuration, the at least one support brace can move away from the plurality of support members.

In at least one aspect of the present disclosure, the at least one support brace is U-shaped. In at least one aspect of the present disclosure, the plurality of wheels can be adjustably connected to the plurality of support members. In at least one aspect of the present disclosure, the at least one support brace is adjustably connected to the plurality of support members via at least one adjustable component. The at least one support brace can slide along a track of the adjustable component. In at least one aspect of the present disclosure, the at least one support brace includes at least one extension component. The at least one extension component can adjust a position of the at least one support brace. In at least one aspect of the present disclosure, the modular stroller frame can further include a storage container. In the collapsed configuration, the at least one support brace, the plurality of support members, and the plurality of wheels can be positioned inside the storage container. In at least one aspect of the present disclosure, the storage container includes a backpack.

In at least one aspect of the present disclosure, the modular stroller frame includes at least one support brace, a plurality of support members, a base, and a plurality of wheels. The at least one support brace can be adjustably connected to the plurality of support members. The base can be adjustably connected to the plurality of support members. The plurality of wheels can be adjustably connected to the plurality of support members. The modular stroller frame can move between a collapsed configuration and an open configuration. When moving from the collapsed configuration to the open configuration, the at least one support brace can move away from the plurality of support members.

In at least one aspect of the present disclosure, the at least one support brace can include at least one extension component. The at least one support brace can adjust a position of the at least one support brace. In at least one aspect of the present disclosure, the modular stroller frame can include a storage container. When in the collapsed configuration, the at least one support brace, the plurality of support members, and the plurality of wheels can be positioned inside the storage container. In at least one aspect of the present disclosure, the at least one support brace is U-shaped. In at least one aspect of the present disclosure, the at least one support brace is adjustably connected to the plurality of support members via at least two adjustable connectors. The at least two adjustable connectors can include at least one of a hinge joint, a telescoping joint, a ball-and-socket joint, a swivel joint, a sliding joint, a pivot joint, a latching joint, and/or a locking joint. In at least one aspect of the present disclosure, the base can receive a seat via at least one attachment component. The at least one attachment component can include a latch, a hook and loop fastener, and/or a harness.

### BRIEF DESCRIPTION OF THE DRAWINGS

The embodiments illustrated, described, and discussed herein are illustrative of the present disclosure. As these embodiments of the present disclosure are described with reference to illustrations, various modifications, or adaptations of the methods and or specific structures described may become apparent to those skilled in the art. It will be appreciated that modifications and variations are covered by the above teachings and within the scope of the appended claims without departing from the spirit and intended scope thereof. All such modifications, adaptations, or variations that rely upon the teachings of the present disclosure, and through which these teachings have advanced the art, are considered to be within the spirit and scope of the present disclosure. Hence, these descriptions and drawings should not be considered in a limiting sense, as it is understood that the present disclosure is in no way limited to only the embodiments illustrated.

FIG. 1A illustrates a top perspective view of a modular stroller frame according to at least one aspect of the present disclosure.

FIG. 1B illustrates a side view of the modular stroller frame shown in FIG. 1A.

FIG. 1C illustrates a front view of the modular stroller frame shown in FIG. 1A.

FIG. 1D illustrates a top view of the modular stroller frame shown in FIG. 1A.

FIG. 2A illustrates a front perspective view of a modular stroller frame according to at least one aspect of the present disclosure.

FIG. 2B illustrates a side view of the modular stroller frame shown in FIG. 2A.

FIG. 2C illustrates a front view of the modular stroller frame shown in FIG. 2A.

FIG. 2D illustrates a top view of the modular stroller frame shown in FIG. 2A.

FIG. 3A illustrates a perspective view of a modular stroller frame according to at least one aspect of the present disclosure.

FIG. 3B illustrates a side view of the modular stroller frame shown in FIG. 3A.

FIG. 3C illustrates a front view of the modular stroller frame shown in FIG. 3A.

FIG. 3D illustrates a top view of the modular stroller frame shown in FIG. 3A.

FIG. 4A illustrates a side perspective view of a modular stroller according to at least one embodiment of the present disclosure.

FIG. 4B illustrates a side perspective view of the modular stroller as shown in FIG. 4A.

FIG. 4C illustrates a rear perspective view of the modular stroller as shown in FIG. 4A.

FIG. 4D illustrates a front perspective view of the modular stroller as shown in FIG. 4A.

FIG. 5A illustrates a side view of a modular stroller according to one embodiment of the present disclosure.

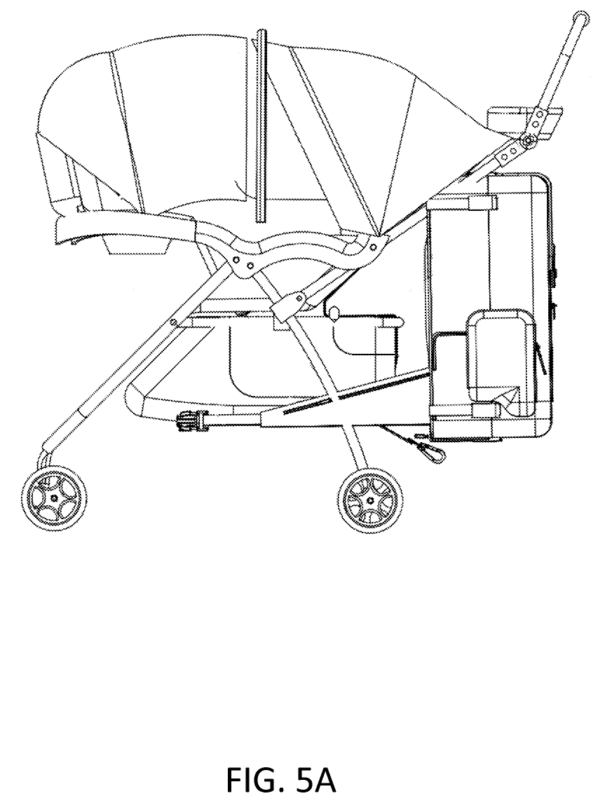

FIG. 5B illustrates a top view of the modular stroller shown in FIG. 5A.

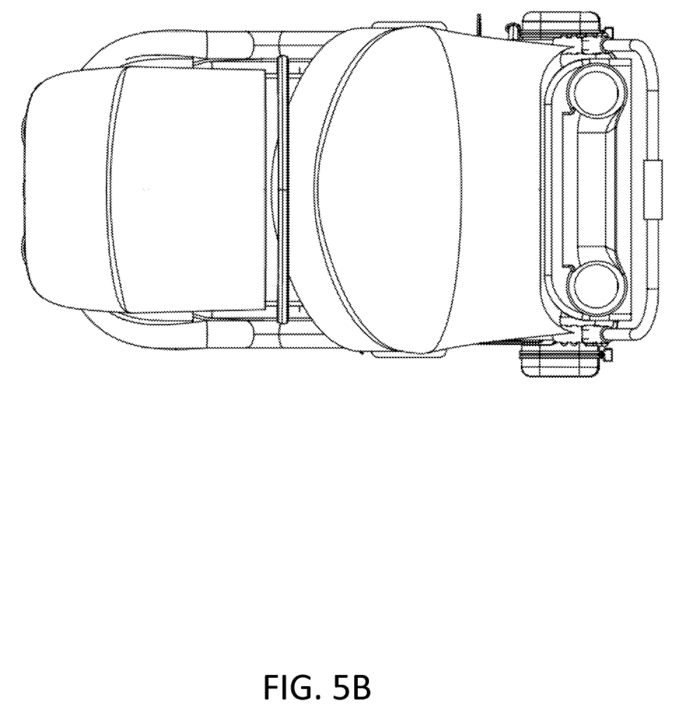

FIG. 5C illustrates a rear view of the modular stroller shown in FIG. 5A.

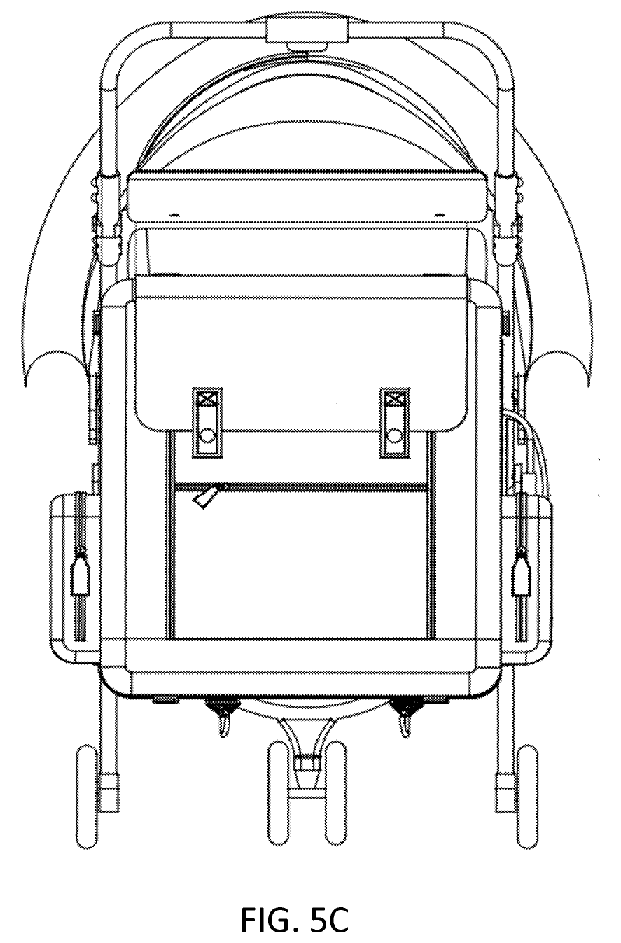

FIG. 6A illustrates a side perspective view of a modular stroller in a backpack according to one embodiment of the present disclosure.

FIG. 6B illustrates a side perspective view of the modular stroller stored in the backpack shown in FIG. 6A.

FIG. 6C illustrates a side perspective view of the modular stroller stored in the backpack shown in FIG. 6A.

FIG. 6D illustrates a rear perspective view of the modular stroller stored in the backpack shown in FIG. 6A.

FIG. 6E illustrates a front perspective view of the modular stroller stored in the backpack shown in FIG. 6A.

FIG. 7A illustrates a side perspective view of a frame of a modular stroller according to one embodiment of the present disclosure.

FIG. 7B illustrates a side perspective view of the frame of a modular stroller shown in FIG. 7A.

FIG. 8A illustrates a perspective view of a modular stroller system in a deployed configuration according to at least one aspect of the present disclosure.

FIG. 8B illustrates a top view of the modular stroller system shown in FIG. 8A in the deployed configuration.

FIG. 8C illustrates a side view of the modular stroller system shown in FIG. 8A.

FIG. 8D illustrates a front view of the modular stroller system shown in FIG. 8A.

FIG. 8E illustrates a rear view of the modular stroller system shown in FIG. 8A in a folded configuration.

FIG. 8F illustrates a side view of the modular stroller system shown in FIG. 8A in the folded configuration.

FIG. 8G illustrates a perspective view of the modular stroller system shown in FIG. 8A with an auxiliary handle in an extended position.

FIG. 8H illustrates a bottom view of the modular stroller system shown in FIG. 8A.

### DETAILED DESCRIPTION

For the purpose of promoting an understanding of the present disclosure, reference will be made to preferred embodiments and specific language will be used to describe the same. It will nevertheless be understood that no limitation of the scope of the disclosure is thereby intended, such alteration and further modifications of the disclosure as illustrated herein, being contemplated as would normally occur to one skilled in the art to which the disclosure relates.

Articles “a” and “an” are used herein to refer to one or to more than one (i.e., at least one) of the grammatical object of the article. By way of example, “a composite” means at least one composite and can include more than one composite.

Throughout the specification, the terms “about” and/or “approximately” may be used in conjunction with numerical values and/or ranges. The term “about” is understood to mean those values near to a recited value. For example, “about 40 [units]” may mean within +/- 25% of 40 (e.g., from 30 to 50), within +/- 20%, +/- 15%, +/- 10%, +/- 9%, +/-8 %, +/- 7%, +/- 6%, +/- 5%, +/- 4%, +/- 3%, +/-2 %, +/- 1%, less than +/- 1%, or any other value or range of values therein or there below. Furthermore, the phrases “less than about [a value]” or “greater than about [a value]” should be understood in view of the definition of the term "about" provided herein. The terms "about" and "approximately" may be used interchangeably.

As used herein, the verb “comprise” as is used in this description and in the claims and its conjugations are used in its non-limiting sense to mean that items following the word are included, but items not specifically mentioned are not excluded.

Throughout the specification the word “comprising,” or variations such as “comprises” or “comprising,” will be understood to imply the inclusion of a stated element, integer or step, or group of elements, integers, or steps, but not the exclusion of any other element, integer or step, or group of elements, integers, or steps. The present disclosure may suitably “comprise”, “consist of”, or “consist essentially of”, the steps, elements, and/or reagents described in the claims.

It is further noted that the claims may be drafted to exclude any optional element. As such, this statement is intended to serve as antecedent basis for use of such exclusive terminology as “solely”, “only”, and the like in connection with the recitation of claim elements, or the use of a “negative” limitation.

Unless defined otherwise, all technical and scientific terms used herein have the same meanings as commonly understood by one of ordinary skill in the art to which this disclosure belongs. Preferred methods, devices, and materials are described, although any methods and materials similar or equivalent to those described herein can be used in the practice or testing of the present disclosure. All references cited herein are incorporated by reference in their entirety.

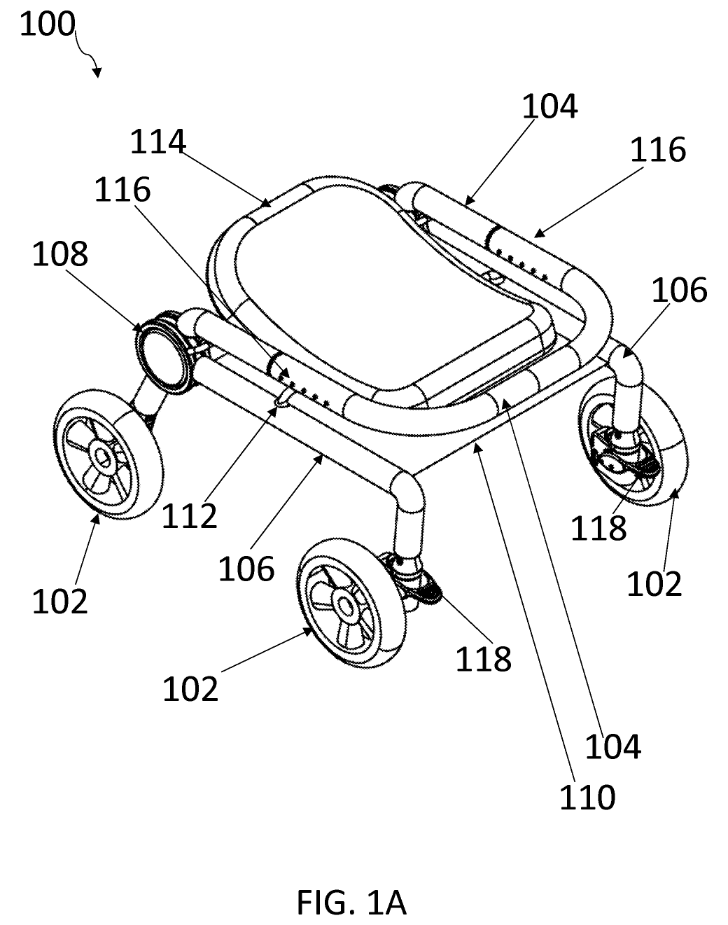

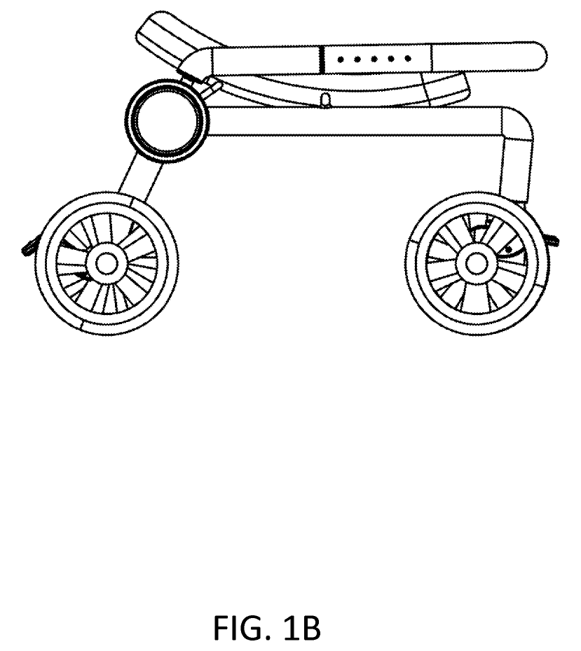

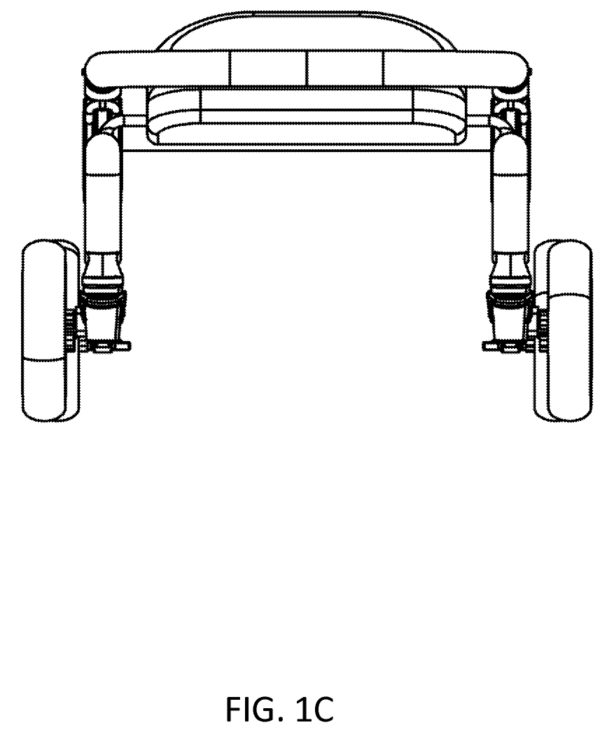

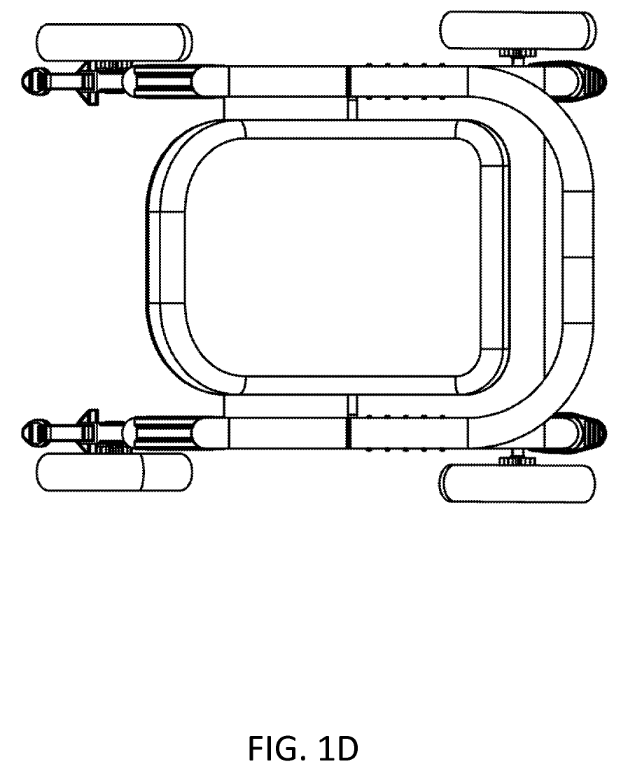

In at least one aspect of the present disclosure, a modular stroller frame is disclosed. In at least one iteration of the present disclosure, as shown in FIGS. 1A – 1D, the modular stroller frame 100 can include a plurality of wheels 102, a U-shaped support brace 104, and at least two support members 106 adjustably connected to the U-shaped support brace 104. In at least one aspect of the present disclosure, the U-shaped support brace is a unitary piece. The U-shaped support brace may be a combination of two or more components. The at least two support members 106 can be adjustably connected to one or more wheels of the plurality of wheels 102 via an adjustment component 108. Advantageously, this enables the wheels to be replaced as desired (e.g., bigger size, worn out). The modular stroller frame 100 may include a layer of material 110 (e.g., covering) positioned between the at least two support members 106. The layer of material may be of varying sizes and material. Each support member of the at least two support members 106 can receive an attachment component 112 (e.g., fastener) corresponding to a base 114. The base 114 can receive a seat designed to support an infant or toddler. The U-shaped support brace 104 may include one or more adjustable components 116 designed to modify a position of the U-shaped support brace.

In at least one aspect of the present disclosure, a modular stroller including a support brace is disclosed. The support brace may be U-shaped, square shaped, curved, or other similar designs that provide an ergonomic modular stroller. The support brace can be adjustably connected to one or more support members of the modular stroller. Advantageously, the adjustable connection enables repositioning of the support brace and/or the plurality of support members to a desired position. Further, the support brace can be positioned to reduce the overall size and/or footprint of the modular stroller to improve the storage and transportation of the modular stroller. In at least one aspect of the present disclosure, the support brace may include an adjustable handle component. The adjustable handle component may be integrated or removably connected to the support brace. The adjustable handle component can modify a length, height, and/or angle of the handle to a desired height.

In at least one aspect of the present disclosure, a modular stroller including a base is disclosed. The base can be removably attached to one or more support members of the modular stroller. The base is configured to receive a seat. For example, and without limitation, the seat can include a car seat, a toddler seat, a rear-facing seat, a front-facing seat and/or other seats for supporting and transporting an infant or toddler. The base can support seats of varying sizes. The base may include a latch, a harness, or other similar attachment mechanisms to receive a corresponding seat.

In at least one aspect of the present disclosure, a modular stroller including a plurality of support members is disclosed. The plurality of support members may be adjustably connected to a support brace. The plurality of support members may be adjustably connected to a plurality of wheels. The plurality of support members can receive a base designed to support a seat. The plurality of support members can extend away from and/or move toward the support brace. For example, and without limitation, the plurality of support members may move toward the support brace to reduce an overall size of the modular stroller. Advantageously, this improves the ease of storing and transporting the modular stroller. The plurality of support members may include a material that is lightweight and flexible.

In at least one aspect of the present disclosure, a modular stroller including a plurality of wheels is disclosed. The plurality of wheels can be permanently attached to the modular stroller frame. Alternatively, the plurality of wheels may be removably attached to the modular stroller frame. Advantageously, this enables the tires to be swapped as necessary. For example, and without limitation, the wheels may be swapped based on a surface (e.g., cushion wheels for smooth surfaces, shock absorption wheels for rough terrains). The modular stroller frame can further include a wheel braking system. The wheel braking system may include a centralized braking system designed for simultaneous locking of all of the wheels of the plurality of wheels.

In at least one aspect of the present disclosure, a modular stroller frame including a plurality of adjustable components is disclosed. The plurality of adjustable components can connect a plurality of components of the modular stroller frame (e.g., support brace, support member, wheels) and enable repositioning of one or more components. The plurality of adjustable components can be configured to releasably engage one or more components. For example, and without limitation, a modular stroller frame may include an adjustable connector to releasably engage a wheel of the modular stroller frame. The adjustable connector can engage and release the wheel to enable swapping of the wheel as desired.

In at least one aspect of the present disclosure, the modular stroller frame can further include one or more modular storage compartments and/or accessories. For example, and without limitation, the modular storage compartments and/or accessories may include a detachable diaper bag, an insulated bottle holder, a supplies organizer, a phone holder, and other systems or accessories.

In at least one aspect of the present disclosure, the modular stroller frame can include carbon steel, stainless steel, aluminum alloy, magnesium alloy, plastic-reinforced composites, rubber, plastic, fabric, (e.g., polyester), and other similar materials. In at least one aspect of the present disclosure, a modular stroller frame designed to meet the standards of ASTM F833-21 is disclosed. “Standard Consumer Safety Performance Specification for Carriages and Strollers” – ASTM F833:021, ASTM International, 2021 is herein incorporated by reference in its entirety. In at least one aspect of the present disclosure, when in the collapsed configuration, the modular stroller frame includes a footprint of about 22 inches by 14 inches by 9 inches. In at least one aspect of the present disclosure, the modular stroller frame includes one or more color-coded components. The color-coded components can indicate proper positioning and functionality of the corresponding components to improve manufacturing and installation. In at least one aspect of the present disclosure, the modular stroller frame is configured to move into a collapsed configuration with one hand of a user. For example, and without limitation, pressure can be applied to the support brace to move the support brace toward a base of the modular stroller frame. As the support brace moves toward the base, the base, the plurality of support members, and/or the plurality of wheels can collapse toward the support brace to reduce the size of the modular stroller frame.

In at least one aspect of the present disclosure, each wheel of the plurality of wheels 102 is connected to at least one support member 106 of the frame. The plurality of wheels may be connected via an adjustable component (e.g., ball and socket joint). The modular stroller frame can further include a control device and/or system for controlling the movement of the wheels 118.

In at least one aspect of the present disclosure, the modular stroller frame includes a fastener for securing one or more components. The fastener may include a screw, a bolt, a rivet, a snap fastener, a quick-release pin, a hook and loop fastener, a snap-fit connector, or other similar fasteners. In at least one aspect of the present disclosure, the modular stroller frame may include a joint for enabling the movement of one or more components. The joint may be positioned between one or more support members, the support members and the support brace, and/or the support members and the plurality of wheels. In at least one aspect of the present disclosure, the modular stroller frame includes a wheel locking mechanism. The wheel locking mechanism may include an axle brake, an individual wheel brake, a swivel wheel lock, a cable-actuated brake, a drum brake, a disc brake, and/or a parking brake.

In at least one aspect of the present disclosure, the modular stroller frame is designed for swapping the plurality of wheels. The modular stroller frame can include a device and/or system for releasably engaging the plurality of wheels. For example, and without limitation, the modular stroller frame may include a quick-release axle, a detent pin and groove system, a cam-lock axle and lever, a snap-fit socket, and/or a fork and hub system.

In at least one aspect of the present disclosure, the modular stroller frame can move between a collapsed configuration and an open configuration. When moving from the collapsed configuration to the open configuration, the U-shaped support brace can move away from the plurality of support members to a substantially vertical position. In the open configuration, the U-shaped support member enables users to push the modular stroller frame. Additionally, a base of the modular stroller frame can be accessed to receive a seat for transporting a toddler or infant. In the collapsed configuration, the modular stroller frame can be stored in a container (e.g., backpack). Advantageously, this improves the transportation of the modular stroller frame during travel.

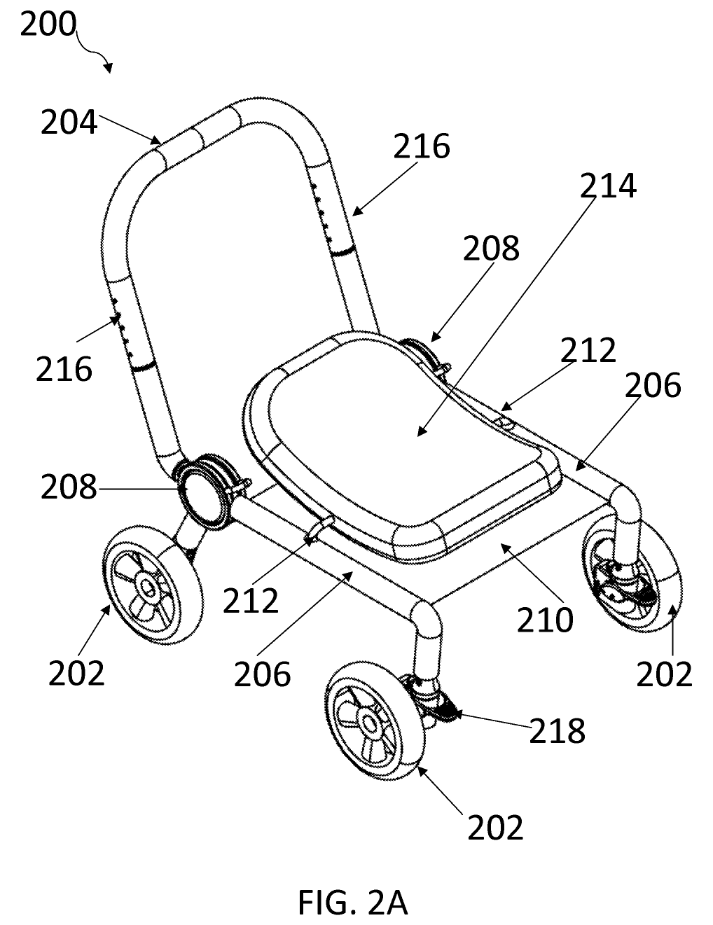

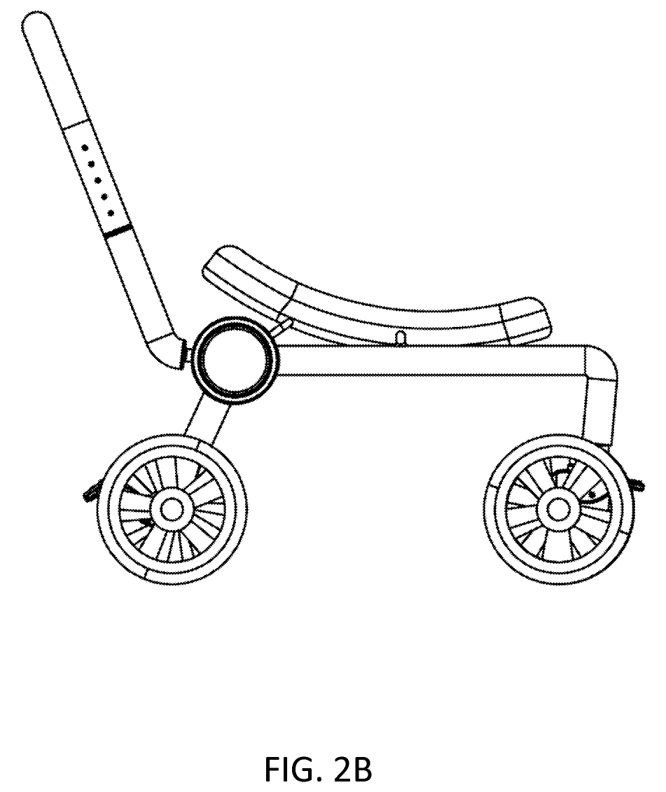

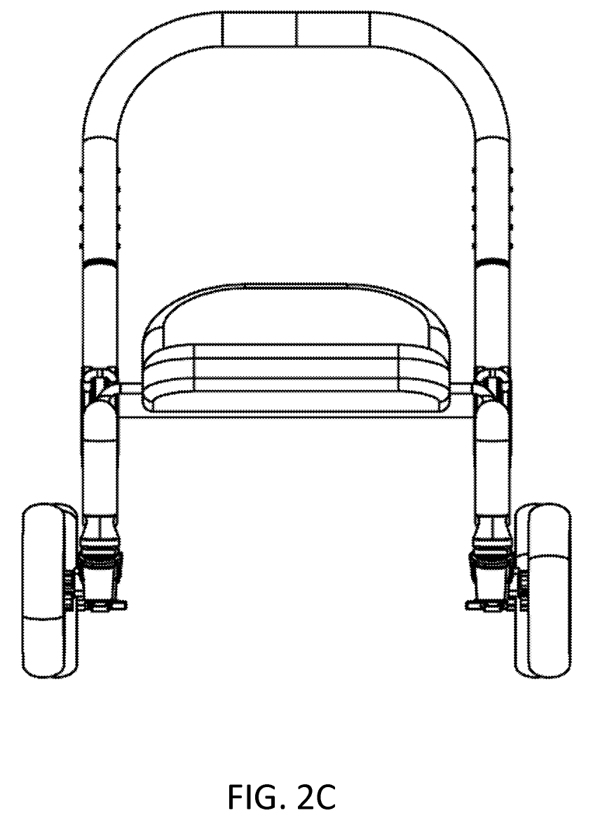

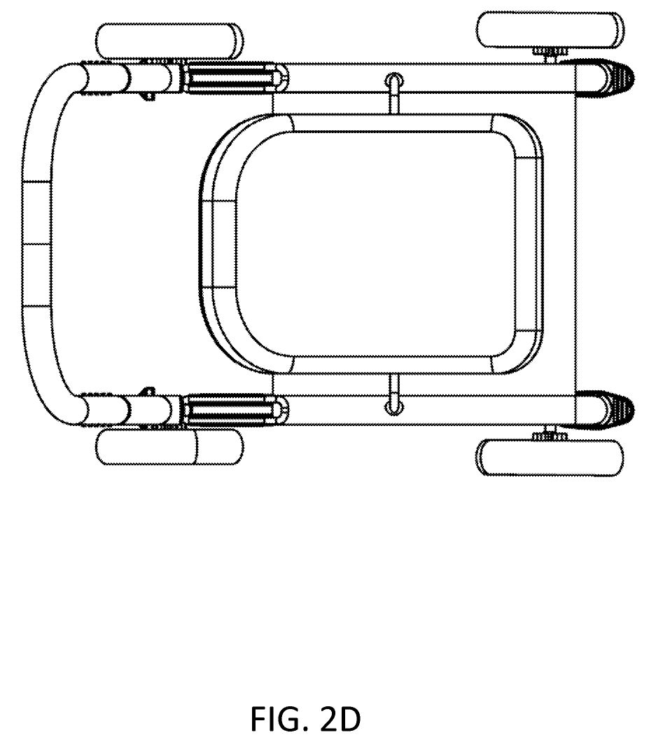

FIGS. 2A-2D illustrate a modular stroller frame 200 according to at least one aspect of the present disclosure. The modular stroller frame 200 can include a frame and a plurality of wheels 202. The frame can include a U-shaped support member 204 (e.g. support brace) and at least two support members 206 adjustably connected to the U-shaped support member 204. The at least two support members 206 can be adjustably connected to one or more wheels of the plurality of wheels 202 via an adjustment component 208. The modular stroller frame may include a layer of material 210 (e.g., covering) positioned between the at least two support members. Each support member of the at least two support members 206 can receive an attachment component 212 (e.g., fastener) from a corresponding base 214. The base 214 can receive a seat designed to support an infant or toddler. The U-shaped support brace 204 may include one or more adjustable components 216 designed to modify a position of the U-shaped support brace.

In at least one aspect of the present disclosure, a modular stroller including a support brace is disclosed. The support brace may be U-shaped, square shaped, curved, or other similar designs that provide an ergonomic modular stroller. The support brace can be adjustably connected to one or more support members of the modular stroller. Advantageously, the adjustable connection enables repositioning of the support brace and/or the plurality of support members to a desired position. Further, the support brace can be positioned to reduce the overall size and/or footprint of the modular stroller to improve the storage and transportation of the modular stroller. In at least one aspect of the present disclosure, the support brace may include an adjustable handle component. The adjustable handle component may be integrated or removably connected to the support brace. The adjustable handle component can modify a length, height, and/or angle of the handle to a desired height.

In at least one aspect of the present disclosure, a modular stroller including a base is disclosed. The base can be removably attached to one or more support members of the modular stroller. The base is configured to receive a seat. For example, and without limitation, the seat can include a car seat, a toddler seat, a rear-facing seat, a front-facing seat and/or other seats for supporting and transporting an infant or toddler. The base can support seats of varying sizes. The base may include a latch, a harness, or other similar attachment mechanisms to receive a corresponding seat.

In at least one aspect of the present disclosure, a modular stroller including a plurality of support members is disclosed. The plurality of support members may be adjustably connected to a support brace. The plurality of support members may be adjustably connected to a plurality of wheels. The plurality of support members can receive a base designed to support a seat. The plurality of support members can extend away from and/or move toward the support brace. For example, and without limitation, the plurality of support members may move toward the support brace to reduce the overall size of the modular stroller. Advantageously, this improves the ease of storing and transporting the modular stroller. The plurality of support members may include a material that is lightweight and flexible.

In at least one aspect of the present disclosure, a modular stroller including a plurality of wheels is disclosed. The plurality of wheels can be permanently attached to the modular stroller frame. Alternatively, the plurality of wheels may be removably attached to the modular stroller frame. Advantageously, this enables the tires to be swapped as necessary. For example, and without limitation, the wheels may be swapped based on a surface (e.g., cushion wheels for smooth surfaces, shock absorption wheels for rough terrains). The modular stroller frame can further include a wheel braking system. The wheel braking system may include a centralized braking system designed for simultaneous locking of all of the wheels of the plurality of wheels.

In at least one aspect of the present disclosure, a modular stroller frame including a plurality of adjustable components is disclosed. The plurality of adjustable components can connect a plurality of components of the modular stroller frame (e.g., support brace, support member, wheels) and enable repositioning of one or more components. The plurality of adjustable components can be configured to releasably engage one or more components. For example, and without limitation, a modular stroller frame may include an adjustable connector to releasably engage a wheel of the modular stroller frame. The adjustable connector can engage and release the wheel to enable swapping of the wheel as desired.

In at least one aspect of the present disclosure, the modular stroller frame can further include one or more modular storage compartments and/or accessories. For example, and without limitation, the modular storage compartments and/or accessories may include a detachable diaper bag, an insulated bottle holder, a supplies organizer, a phone holder, and other systems or accessories.

In at least one aspect of the present disclosure, the modular stroller frame can include carbon steel, stainless steel, aluminum alloy, magnesium alloy, plastic-reinforced composites, rubber, plastic, fabric, (e.g., polyester), and other similar materials. In at least one aspect of the present disclosure, a modular stroller frame designed to meet the standards of ASTM F833-21 is disclosed. “Standard Consumer Safety Performance Specification for Carriages and Strollers” – ASTM F833:021, ASTM International, 2021 is herein incorporated by reference in its entirety. In at least one aspect of the present disclosure, when in the collapsed configuration, the modular stroller frame includes a footprint of about 22 inches by 14 inches by 9 inches. In at least one aspect of the present disclosure, the modular stroller frame includes one or more color-coded components. The color-coded components can indicate proper positioning and functionality of the corresponding components to improve manufacturing and installation. In at least one aspect of the present disclosure, the modular stroller frame is configured to move into a collapsed configuration with one hand of a user. For example, and without limitation, pressure can be applied to the support brace to move the support brace toward a base of the modular stroller frame. As the support brace moves toward the base, the base, the plurality of support members, and/or the plurality of wheels can collapse toward the support brace to reduce the size of the modular stroller frame.

In at least one aspect of the present disclosure, each wheel of the plurality of wheels is connected to at least one support member of the frame. The plurality of wheels may be connected via an adjustable component (e.g., ball and socket joint). The modular stroller frame further includes an adjustment device for controlling the rotation of the wheels 218.

In at least one aspect of the present disclosure, the modular stroller frame includes a fastener for securing one or more components. The fastener may include a screw, a bolt, a rivet, a snap fastener, a quick-release pin, a hook and loop fastener, a snap-fit connector, or other similar fasteners. In at least one aspect of the present disclosure, the modular stroller frame may include a joint for enabling the movement of one or more components. The joint may include a hinge joint, a telescoping joint, a ball-and-socket joint, a swivel joint, a sliding joint, a pivot joint, a latching joint, and/or a locking joint. In at least one aspect of the present disclosure, the modular stroller frame includes a wheel locking mechanism. The wheel locking mechanism may include an axle brake, an individual wheel brake, a swivel wheel lock, a cable-actuated brake, a drum brake, a disc brake, and/or a parking brake.

In at least one aspect of the present disclosure, the modular stroller frame is designed for swapping the plurality of wheels. The modular stroller frame can include a device and/or system for releasably engaging the plurality of wheels. For example, and without limitation, the modular stroller frame may include a quick-release axle, a detent pin and groove system, a cam-lock axle and lever, a snap-fit socket, and/or a fork and hub system.

The modular stroller frame can move between a collapsed configuration and an open configuration. When moving from the collapsed configuration to the open configuration, the U-shaped support brace can move away from the plurality of support members to a substantially vertical position. In the open configuration, the U-shaped support member enables users to push the modular stroller frame. Additionally, a base of the modular stroller frame can be accessed to receive a seat for transporting a toddler or infant. In the collapsed configuration, the modular stroller frame can be stored in a container (e.g., backpack). Advantageously, this improves the transportation of the modular stroller frame during travel.

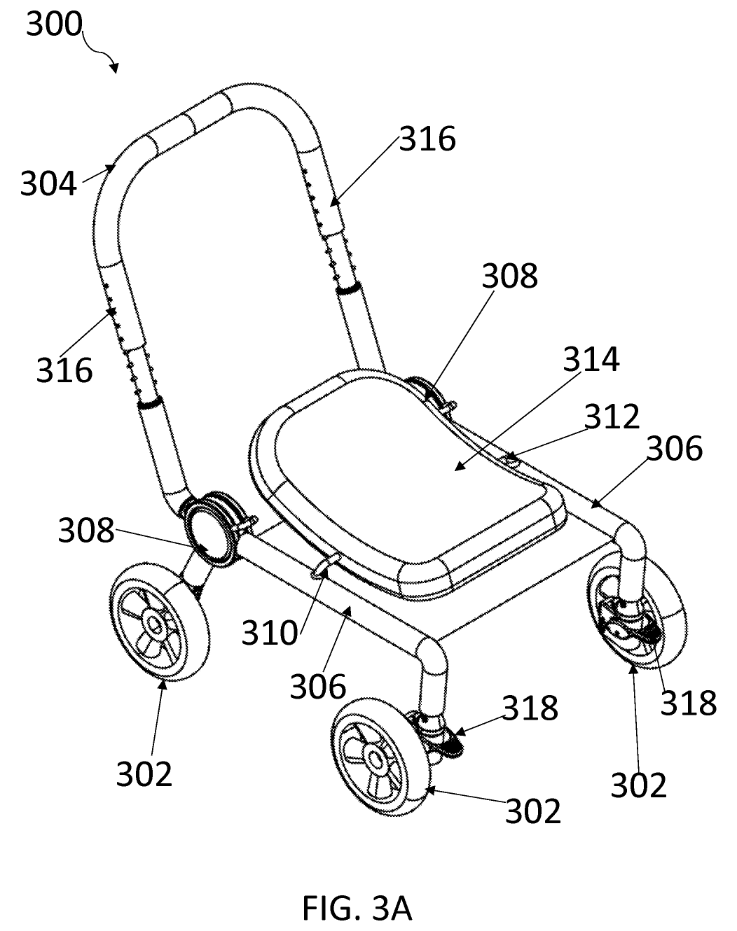

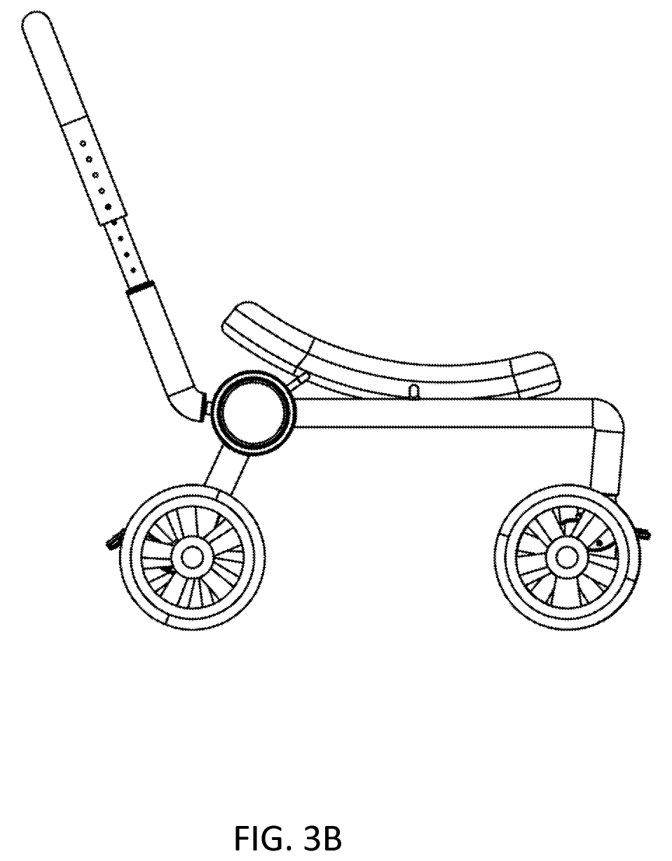

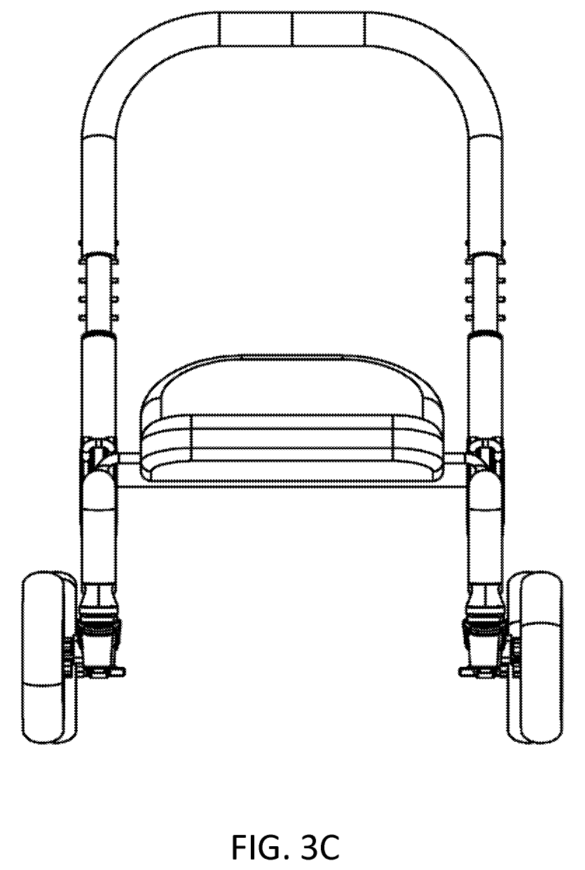

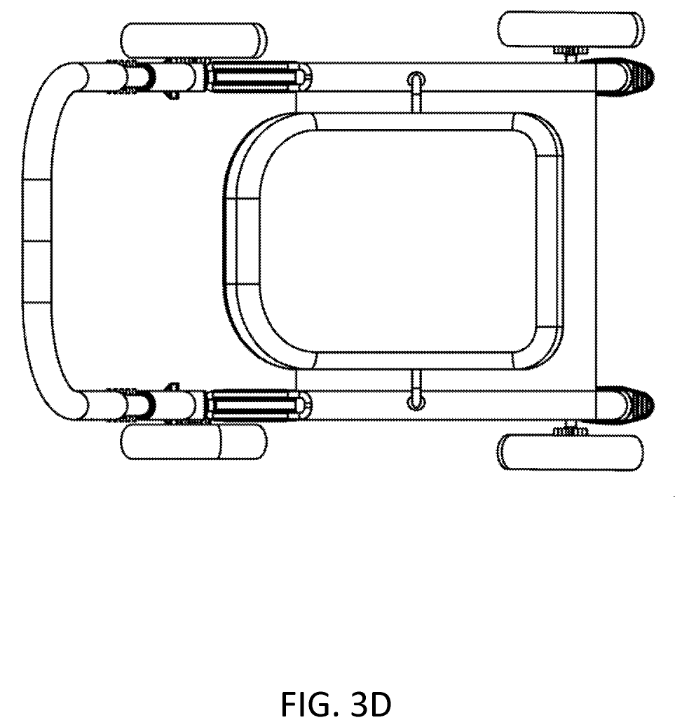

As illustrated in FIGS. 3A-3D, the U-shaped support brace can include at least two adjustment components for extending or shortening a length of the U-shaped support brace. Advantageously, this enables the modular stroller to be customized to a height of a user.

In at least one aspect of the present disclosure, a modular stroller frame is disclosed. For example, and without limitation, as shown in FIG. 3A, the modular stroller frame 300 can include a frame and a plurality of wheels 302. The frame can include a U-shaped support brace 304 and at least two support members 306 adjustably connected to the U-shaped support brace 304. In at least one aspect of the present disclosure, the U-shaped support brace is a unitary piece. The U-shaped support brace may be a combination of two or more components. The at least two support members 306 can be adjustably connected to one or more wheels of the plurality of wheels 302 via an adjustment component 308. Advantageously, this enables the wheels to be replaced as desired (e.g., bigger size, worn out). The modular stroller frame 300 may include a layer of material 310 (e.g., covering) positioned between the at least two support members 306. Each support member of the at least two support members 306 can receive an attachment component 312 (e.g., fastener) from a corresponding base 314. The base 314 can receive releasably engage a seat designed to support an infant and/or toddler. The U-shaped support brace 304 may include one or more adjustable components 316 designed to modify a position of the U-shaped support brace. The one or more adjustable components 316 may include a plurality of slots or holes corresponding to a change in position.

In at least one aspect of the present disclosure, a modular stroller including a support brace is disclosed. The support brace may be U-shaped, square shaped, curved, or other similar designs that provide an ergonomic modular stroller. The support brace can be adjustably connected to one or more support members of the modular stroller. Advantageously, the adjustable connection enables repositioning of the support brace and/or the plurality of support members to a desired position. Further, the support brace can be positioned to reduce the overall size and/or footprint of the modular stroller to improve the storage and transportation of the modular stroller. In at least one aspect of the present disclosure, the support brace may include an adjustable handle component. The adjustable handle component may be integrated or removably connected to the support brace. The adjustable handle component can modify a length, height, and/or angle of the handle to a desired height.

In at least one aspect of the present disclosure, a modular stroller including a base is disclosed. The base can be removably attached to one or more support members of the modular stroller. The base is configured to receive a seat. For example, and without limitation, the seat can include a car seat, a toddler seat, a rear-facing seat, a front-facing seat and/or other seats for supporting and transporting an infant or toddler. The base can support seats of varying sizes. The base may include a latch, a harness, or other similar attachment mechanisms to receive a corresponding seat.

In at least one aspect of the present disclosure, a modular stroller including a plurality of support members is disclosed. The plurality of support members may be adjustably connected to a support brace. The plurality of support members may be adjustably connected to a plurality of wheels. The plurality of support members can receive a base designed to support a seat. The plurality of support members can extend away from and/or move toward the support brace. For example, and without limitation, the plurality of support members may move toward the support brace to reduce the overall size of the modular stroller. Advantageously, this improves the ease of storing and transporting the modular stroller. The plurality of support members may include a material that is lightweight and flexible.

In at least one aspect of the present disclosure, a modular stroller including a plurality of wheels is disclosed. The plurality of wheels can be permanently attached to the modular stroller frame. Alternatively, the plurality of wheels may be removably attached to the modular stroller frame. Advantageously, this enables the tires to be swapped as necessary. For example, and without limitation, the wheels may be swapped based on a surface (e.g., cushion wheels for smooth surfaces, shock absorption wheels for rough terrains). The modular stroller frame can further include a wheel braking system. The wheel braking system may include a centralized braking system designed for simultaneous locking of all of the wheels of the plurality of wheels.

In at least one aspect of the present disclosure, a modular stroller frame including a plurality of adjustable components is disclosed. The plurality of adjustable components can connect a plurality of components of the modular stroller frame (e.g., support brace, support member, wheels) and enable repositioning of one or more components. The plurality of adjustable components can be configured to releasably engage one or more components. For example, and without limitation, a modular stroller frame may include an adjustable connector to releasably engage a wheel of the modular stroller frame. The adjustable connector can engage and release the wheel to enable swapping of the wheel as desired.

In at least one aspect of the present disclosure, the modular stroller frame can further include one or more modular storage compartments and/or accessories. For example, and without limitation, the modular storage compartments and/or accessories may include a detachable diaper bag, an insulated bottle holder, a supplies organizer, a phone holder, and other systems or accessories.

In at least one aspect of the present disclosure, the modular stroller frame can include carbon steel, stainless steel, aluminum alloy, magnesium alloy, plastic-reinforced composites, rubber, plastic, fabric, (e.g., polyester), and other similar materials. In at least one aspect of the present disclosure, a modular stroller frame designed to meet the standards of ASTM F833-21 is disclosed. “Standard Consumer Safety Performance Specification for Carriages and Strollers” – ASTM F833:021, ASTM International, 2021 is herein incorporated by reference in its entirety. In at least one aspect of the present disclosure, when in the collapsed configuration, the modular stroller frame includes a footprint of about 22 inches by 14 inches by 9 inches. In at least one aspect of the present disclosure, the modular stroller frame includes one or more color-coded components. The color-coded components can indicate proper positioning and functionality of the corresponding components to improve manufacturing and installation. In at least one aspect of the present disclosure, the modular stroller frame is configured to move into a collapsed configuration with one hand of a user. For example, and without limitation, pressure can be applied to the support brace to move the support brace toward a base of the modular stroller frame. As the support brace moves toward the base, the base, the plurality of support members, and/or the plurality of wheels can collapse toward the support brace to reduce the size of the modular stroller frame.

In at least one aspect of the present disclosure, each wheel of the plurality of wheels 302 is connected to at least one support member 306 of the frame. The plurality of wheels may be connected via an adjustable component (e.g., ball and socket joint). The modular stroller frame can further include a control device and/or system for controlling the movement of the wheels 318.

In at least one aspect of the present disclosure, the modular stroller frame includes a fastener for securing one or more components. The fastener may include a screw, a bolt, a rivet, a snap fastener, a quick-release pin, a hook and loop fastener, a snap-fit connector, or other similar fasteners. In at least one aspect of the present disclosure, the modular stroller frame may include a joint for enabling the movement of one or more components. The joint may include a hinge joint, a telescoping joint, a ball-and-socket joint, a swivel joint, a sliding joint, a pivot joint, a latching joint, and/or a locking joint. In at least one aspect of the present disclosure, the modular stroller frame includes a wheel locking mechanism. The wheel locking mechanism may include an axle brake, an individual wheel brake, a swivel wheel lock, a cable-actuated brake, a drum brake, a disc brake, and/or a parking brake.

In at least one aspect of the present disclosure, the modular stroller frame is designed for swapping the plurality of wheels. The modular stroller frame can include a device and/or system for releasably engaging the plurality of wheels. For example, and without limitation, the modular stroller frame may include a quick-release axle, a detent pin and groove system, a cam-lock axle and lever, a snap-fit socket, and/or a fork and hub system.

The modular stroller frame can move between a collapsed configuration and an open configuration. When moving from the collapsed configuration to the open configuration, the U-shaped support brace can move away from the plurality of support members to a substantially vertical position. In the open configuration, the U-shaped support brace enables users to push the modular stroller frame. Additionally, a base of the modular stroller frame can be accessed to receive a seat for transporting a toddler or infant. In the collapsed configuration, the modular stroller frame can be stored in a container (e.g., backpack). Advantageously, this improves the transportation of the modular stroller frame during travel.

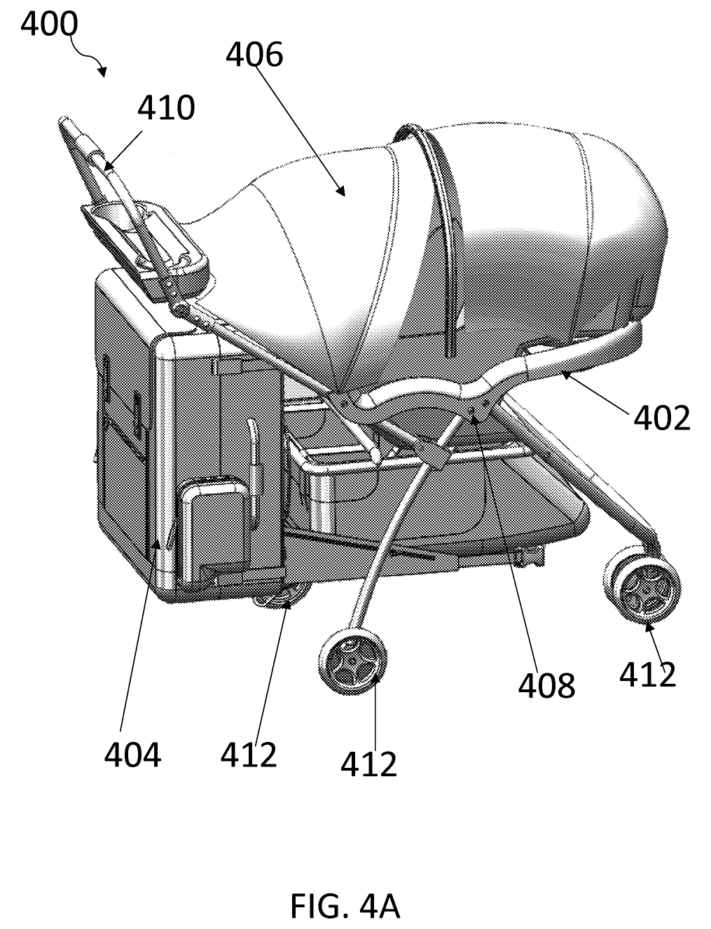

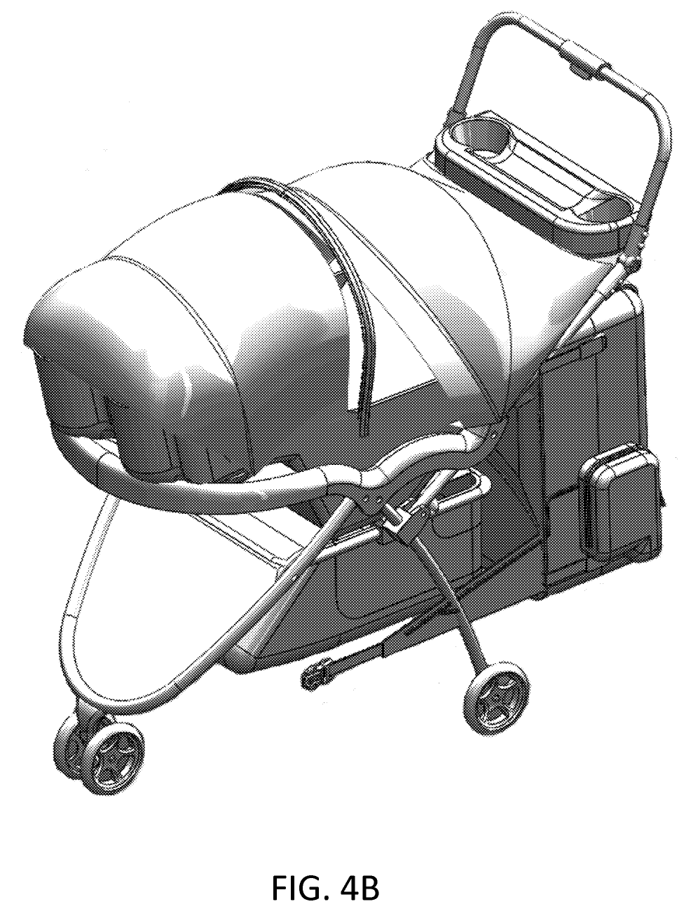

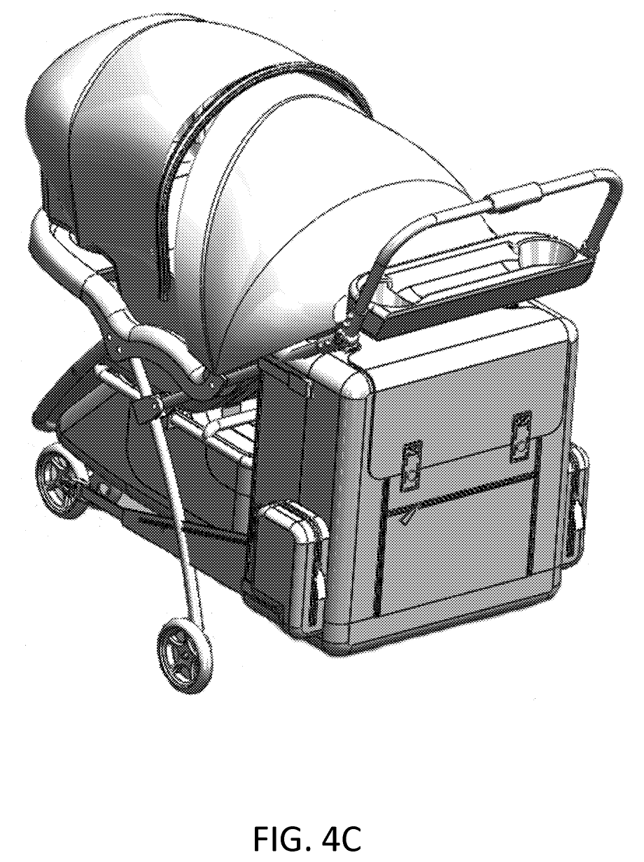

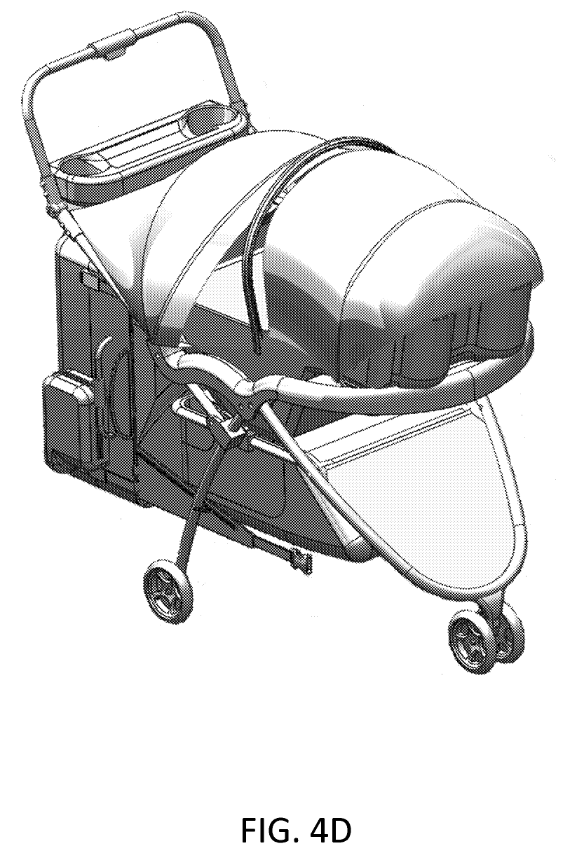

In some embodiments, a modular stroller is disclosed. The modular stroller includes a frame, a backpack, and a seat. The modular stroller is designed to move from an expanded configuration to a stored configuration. In the expanded configuration, the stroller is fully extended as shown in FIGS. 4A – 5C. The backpack can reside on a rear portion of the stroller frame. For example, and without limitation, the backpack resides underneath a handle of the stroller frame.

In at least one aspect of the present disclosure, a modular stroller is disclosed. The modular stroller 400 includes a frame 402, a storage container 404, and a cover 406. In at least one iteration, the frame 402 includes a plurality of sliding hinges 408, a handle 410, a plurality of wheels 412, and a plurality of support members. The frame is configured to receive the storage container 404 (e.g., backpack) and at least one seat. The at least one seat can be any seat designed to support an infant or toddler. The frame can further receive the cover 406 for protecting the at least one seat and a seat occupant. The frame handle 410 provides a leverage point for moving the modular stroller. In some embodiments, the frame handle 410 may include a support platform for carrying containers (e.g., beverages). The support platform may be removably attached to the frame handle.

The collapsible frame is designed to move the plurality of wheels toward each other when moving to a collapsed configuration. For example, and without limitation, the collapsible frame includes at least three wheels. At least two wheels are positioned toward a rear of the frame and at least one wheel is positioned toward a front of the frame. The sliding hinges are designed to move up and down the plurality of support members to increase or decrease the distance between the plurality of wheels. The collapsible frame is further operable to receive a carrying component (e.g., bag) attached to a plurality of bottom support members. The collapsible frame is further operable to receive a backpack positioned on a rear of the collapsible frame. In some embodiments, the collapsible frame, when in the collapsed configuration, is designed to fit inside the backpack. The collapsible frame is further designed to receive a plurality of cover components. For example, and without limitation, the collapsible frame can receive a retractable cover designed to cover a body of the modular stroller.

In at least one aspect of the present disclosure, the collapsible stroller frame can include a frame and a plurality of wheels. The frame can include a U-shaped support brace and at least two support members adjustably connected to the U-shaped support brace. In at least one aspect of the present disclosure, the U-shaped support brace is a unitary piece. The U-shaped support brace may be a combination of two or more components. The at least two support members can be adjustably connected to one or more wheels of the plurality of wheels via an adjustment component. Advantageously, this enables the wheels to be replaced as desired (e.g., bigger size, worn out). The modular stroller frame may include a layer of material (e.g., covering) positioned between the at least two support members. Each support member of the at least two support members can receive an attachment component (e.g., fastener) from a corresponding seat. The U-shaped support brace may include one or more adjustable components designed to modify a position of the U-shaped support brace. The one or more adjustable components may include a plurality of slots or holes corresponding to a change in position.

In at least one aspect of the present disclosure, each wheel of the plurality of wheels is connected to at least one support member of the frame. The plurality of wheels may be connected via an adjustable component (e.g., ball and socket joint). The modular stroller frame can further include a control device and/or system for controlling the movement of the wheels.

In at least one aspect of the present disclosure, the modular stroller frame includes a fastener for securing one or more components. The fastener may include a screw, a bolt, a rivet, a snap fastener, a quick-release pin, a hook and loop fastener, a snap-fit connector, or other similar fasteners. In at least one aspect of the present disclosure, the modular stroller frame may include a joint for enabling the movement of one or more components. The joint may include a hinge joint, a telescoping joint, a ball-and-socket joint, a swivel joint, a sliding joint, a pivot joint, a latching joint, and/or a locking joint. In at least one aspect of the present disclosure, the modular stroller frame includes a wheel locking mechanism. The wheel locking mechanism may include an axle brake, an individual wheel brake, a swivel wheel lock, a cable-actuated brake, a drum brake, a disc brake, and/or a parking brake.

In at least one aspect of the present disclosure, the modular stroller frame is designed for swapping the plurality of wheels. The modular stroller frame can include a device and/or system for releasably engaging the plurality of wheels. For example, and without limitation, the modular stroller frame may include a quick-release axle, a detent pin and groove system, a cam-lock axle and lever, a snap-fit socket, and/or a fork and hub system.

The modular stroller frame can move between a collapsed configuration and an open configuration. When moving from the collapsed configuration to the open configuration, the U-shaped support brace can move away from the plurality of support members to a substantially vertical position. In the open configuration, the U-shaped support brace enables users to push the modular stroller frame. Additionally, a seat of the modular stroller frame can be accessed to receive a toddler, or infant. In the collapsed configuration, the modular stroller frame can be stored in a container (e.g., backpack). Advantageously, this improves the transportation of the modular stroller frame during travel.

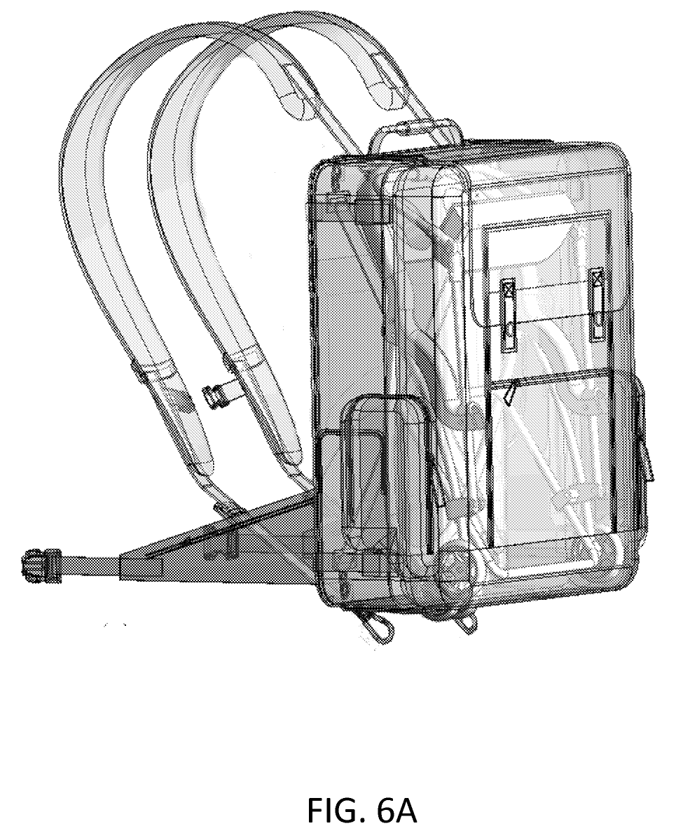

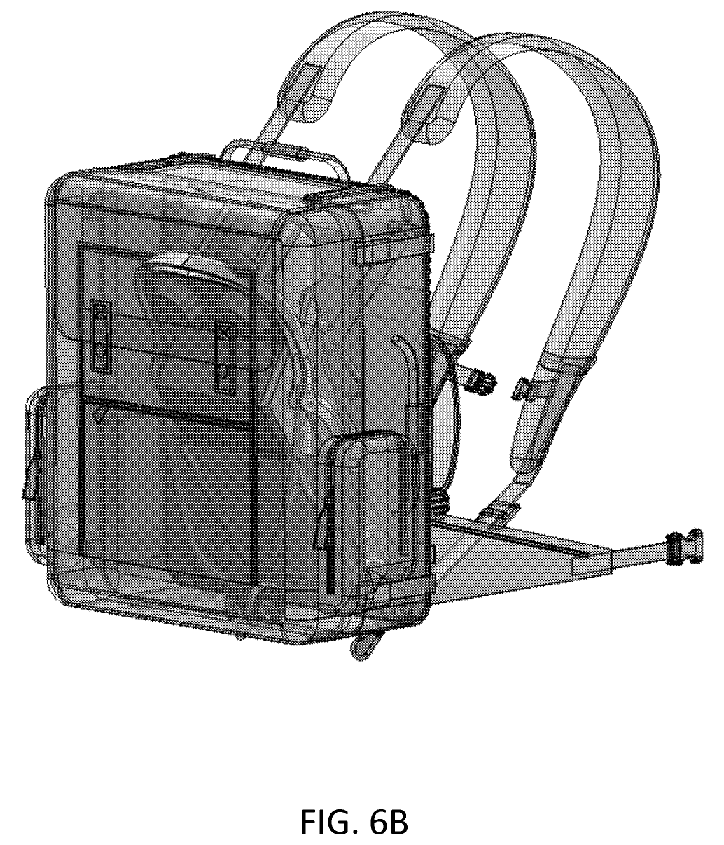

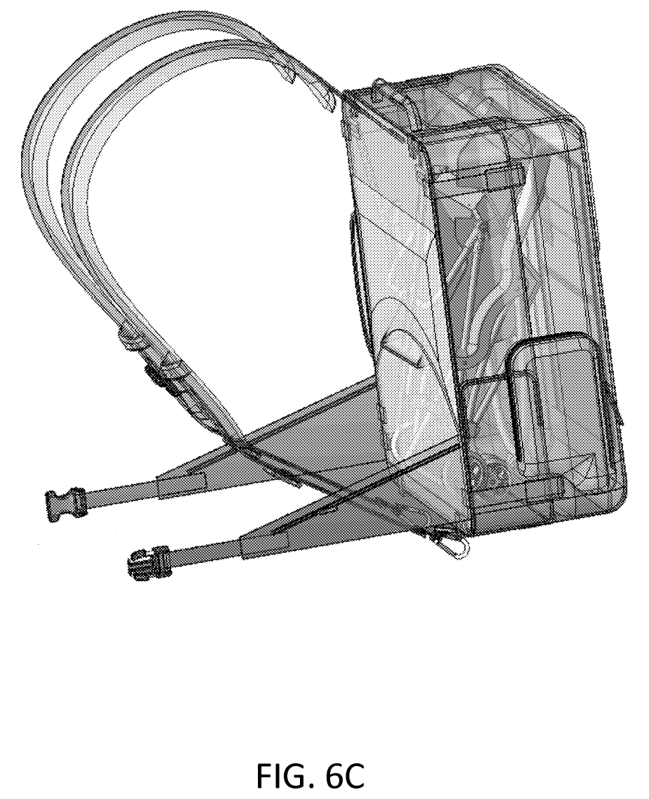

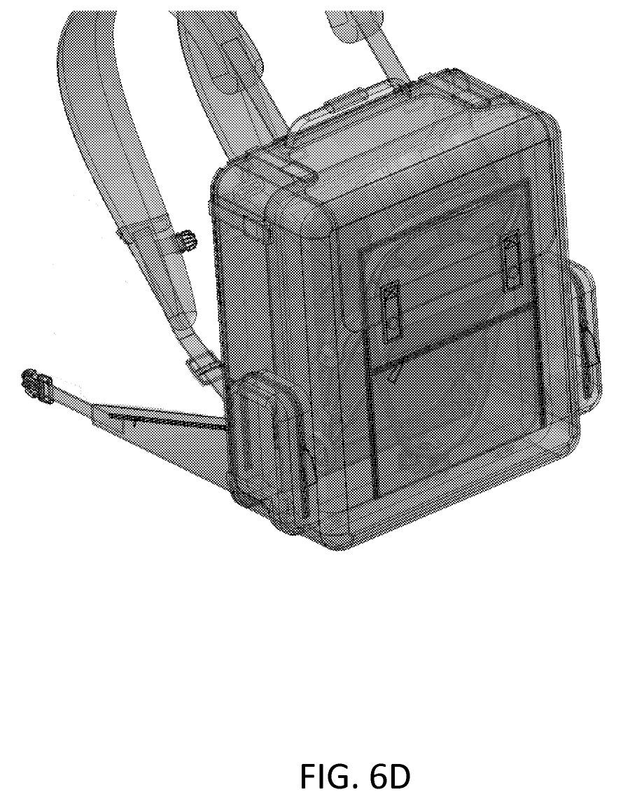

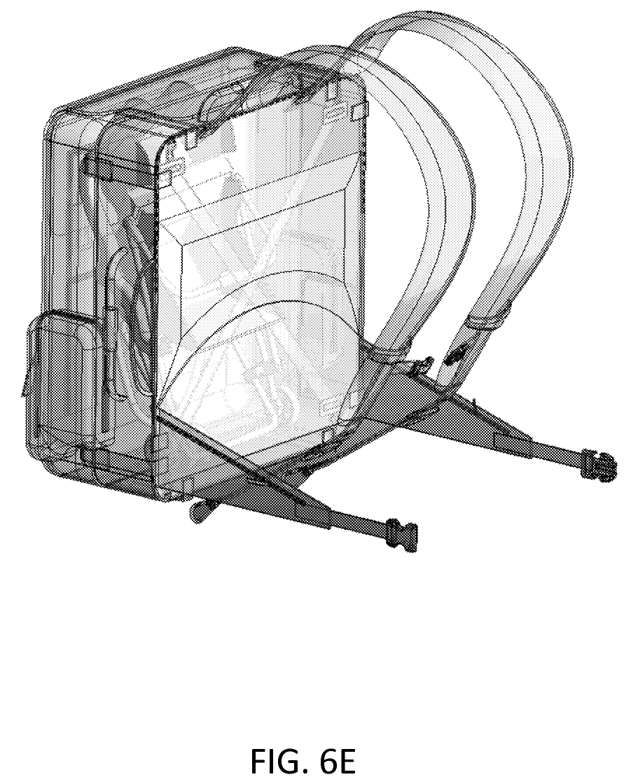

In the stored configuration, as shown in FIGS. 6A to 6E, the modular stroller is configured to be stored in a storage apparatus (e.g., backpack). When transitioning from the expanded configuration to the stored configuration, the stroller frame collapses to reduce the size of the stroller. For example, and without limitation, when moving from the expanded configuration to the stored configuration, the backpack is designed to open a rear panel to receive to the stroller frame as the stroller frame collapses. For further example, and without limitation, the backpack includes a zipper that runs around a portion of the back panel that creates access to the interior of the backpack. For further example, and without limitation, in some embodiments, the cover components of the strollers and the stroller frame are foldable and fit within an interior of the backpack. In some embodiments, the cover components of the stroller and/or the stroller frame collapse into the backpack via a top, bottom, side, front, and/or rear portion of the backpack. In some embodiments, the cover components of the stroller are operable to attach to an exterior surface of the backpack and to provide additional protection. For further example, and without limitation, the cover components may include a material similar to a material of the backpack. In some embodiments, the backpack is completely detachable from the collapsible frame.

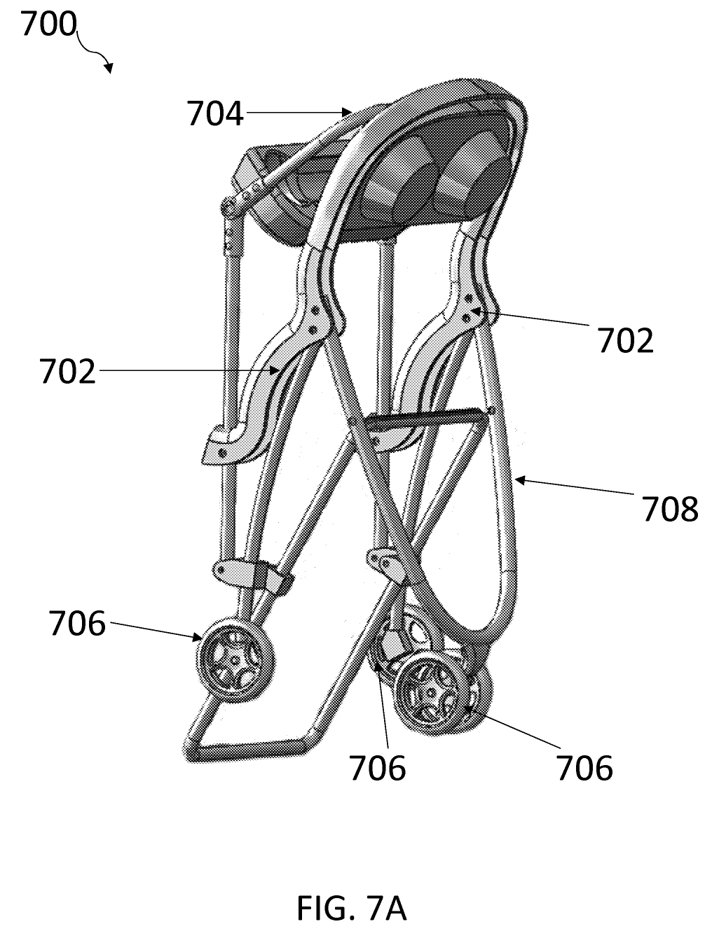

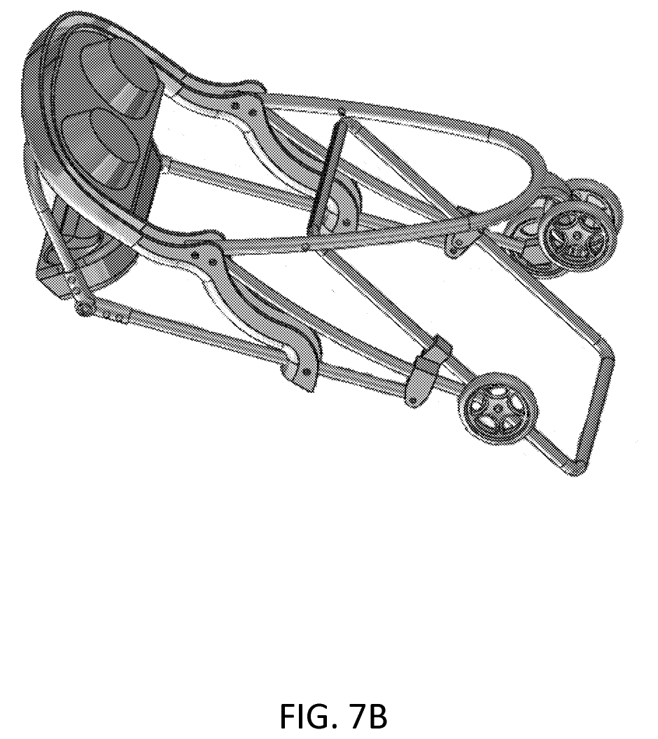

In at least one aspect of the present disclosure, a modular stroller including a collapsible frame is disclosed. For example, and without limitation, as shown in FIGS. 7A and 7B, the collapsible frame 700 includes a plurality of sliding hinges 702, a handle 704, a plurality of wheels 706, and a plurality of support members 708. The collapsible frame is designed to move the plurality of wheels toward each other when moving to a collapsed configuration. For example, and without limitation, the collapsible frame includes at least three wheels. At least two wheels are positioned toward a rear of the frame and at least one wheel is positioned toward a front of the frame. The sliding hinges are designed to move up and down the plurality of support members to increase or decrease the distance between the plurality of wheels. The collapsible frame is further operable to receive a carrying component (e.g., bag) attached to a plurality of bottom support members. The collapsible frame is further operable to receive a backpack positioned on a rear of the collapsible frame. In some embodiments, the collapsible frame, when in the collapsed configuration, is designed to fit inside the backpack. The collapsible frame is further designed to receive a plurality of cover components. For example, and without limitation, the collapsible frame can receive a retractable cover designed to cover a body of the modular stroller.

In at least one aspect of the present disclosure, a modular stroller including a support brace is disclosed. The support brace may be U-shaped, square shaped, curved, or other similar designs that provide an ergonomic modular stroller. The support brace can be adjustably connected to one or more support members of the modular stroller. Advantageously, the adjustable connection enables repositioning of the support brace and/or the plurality of support members to a desired position. Further, the support brace can be positioned to reduce the overall size and/or footprint of the modular stroller to improve the storage and transportation of the modular stroller. In at least one aspect of the present disclosure, the support brace may include an adjustable handle component. The adjustable handle component may be integrated or removably connected to the support brace. The adjustable handle component can modify a length, height, and/or angle of the handle to a desired height.

In at least one aspect of the present disclosure, a modular stroller including a base is disclosed. The base can be removably attached to one or more support members of the modular stroller. The base is configured to receive a seat. For example, and without limitation, the seat can include a car seat, a toddler seat, a rear-facing seat, a front-facing seat and/or other seats for supporting and transporting an infant or toddler. The base can support seats of varying sizes. The base may include a latch, a harness, or other similar attachment mechanisms to receive a corresponding seat.

In at least one aspect of the present disclosure, a modular stroller including a plurality of support members is disclosed. The plurality of support members may be adjustably connected to a support brace. The plurality of support members may be adjustably connected to a plurality of wheels. The plurality of support members can receive a base designed to support a seat. The plurality of support members can extend away from and/or move toward the support brace. For example, and without limitation, the plurality of support members may move toward the support brace to reduce an overall size of the modular stroller. Advantageously, this improves the ease of storing and transporting the modular stroller. The plurality of support members may include a material that is lightweight and flexible.

In at least one aspect of the present disclosure, a modular stroller including a plurality of wheels is disclosed. The plurality of wheels can be permanently attached to the modular stroller frame. Alternatively, the plurality of wheels may be removably attached to the modular stroller frame. Advantageously, this enables the tires to be swapped as necessary. For example, and without limitation, the wheels may be swapped based on a surface (e.g., cushion wheels for smooth surfaces, shock absorption wheels for rough terrains). The modular stroller frame can further include a wheel braking system. The wheel braking system may include a centralized braking system designed for simultaneous locking of all of the wheels of the plurality of wheels.

In at least one aspect of the present disclosure, a modular stroller frame including a plurality of adjustable components is disclosed. The plurality of adjustable components can connect a plurality of components of the modular stroller frame (e.g., support brace, support member, wheels) and enable repositioning of one or more components. The plurality of adjustable components can be configured to releasably engage one or more components. For example, and without limitation, a modular stroller frame may include an adjustable connector to releasably engage a wheel of the modular stroller frame. The adjustable connector can engage and release the wheel to enable swapping of the wheel as desired.

In at least one aspect of the present disclosure, the modular stroller frame can further include one or more modular storage compartments and/or accessories. For example, and without limitation, the modular storage compartments and/or accessories may include a detachable diaper bag, an insulated bottle holder, a supplies organizer, a phone holder, and other systems or accessories.

In at least one aspect of the present disclosure, the modular stroller frame can include carbon steel, stainless steel, aluminum alloy, magnesium alloy, plastic-reinforced composites, rubber, plastic, fabric, (e.g., polyester), and other similar materials. In at least one aspect of the present disclosure, a modular stroller frame designed to meet the standards of ASTM F833-21 is disclosed. “Standard Consumer Safety Performance Specification for Carriages and Strollers” – ASTM F833:021, ASTM International, 2021 is herein incorporated by reference in its entirety. In at least one aspect of the present disclosure, when in the collapsed configuration, the modular stroller frame includes a footprint of about 22 inches by 14 inches by 9 inches. In at least one aspect of the present disclosure, the modular stroller frame includes one or more color-coded components. The color-coded components can indicate proper positioning and functionality of the corresponding components to improve manufacturing and installation. In at least one aspect of the present disclosure, the modular stroller frame is configured to move into a collapsed configuration with one hand of a user. For example, and without limitation, pressure can be applied to the support brace to move the support brace toward a base of the modular stroller frame. As the support brace moves toward the base, the base, the plurality of support members, and/or the plurality of wheels can collapse toward the support brace to reduce the size of the modular stroller frame.

In some aspects of the present disclosure, the modular stroller is designed to transform into a car seat configuration. For example, and without limitation, the support members and slidable hinges of the stroller frame are adjustably connected (e.g., removably attached) to enable the frame to transition from a stroller configuration to a seat configuration. Each support member can be detached from another support member and repositioned to support a car seat configuration. Advantageously, a cushion used in the stroller configuration can be used as a cushion for the car seat. The backpack is designed to attach to a rear and/or a side of the car seat configuration.

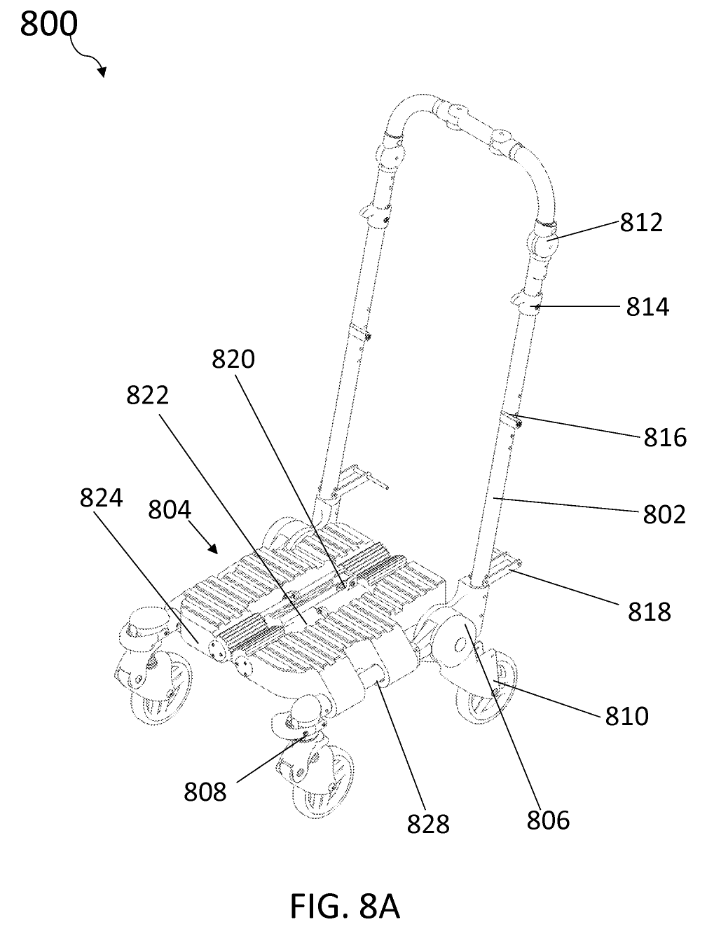

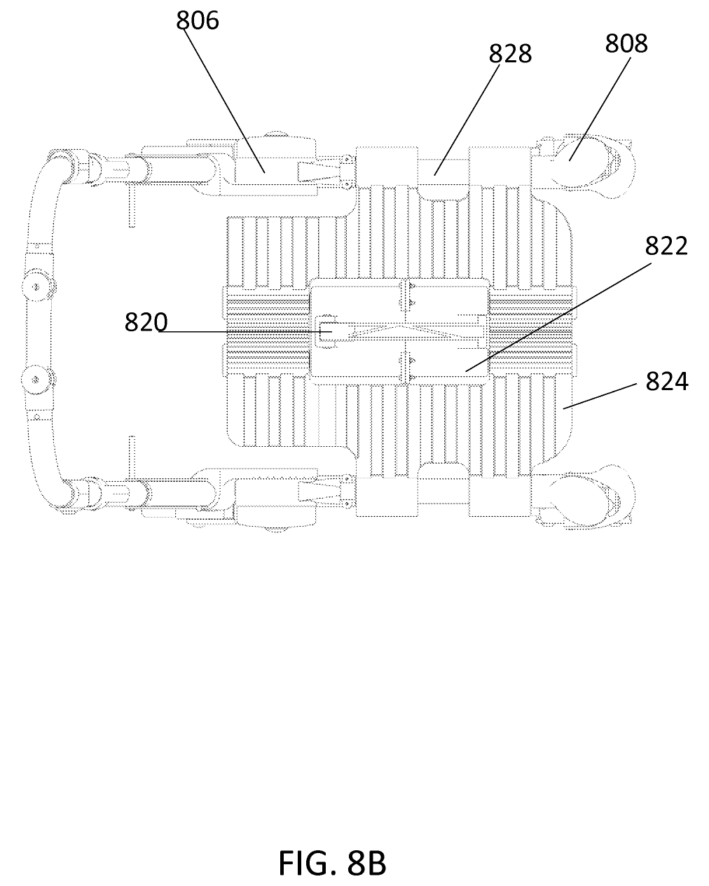

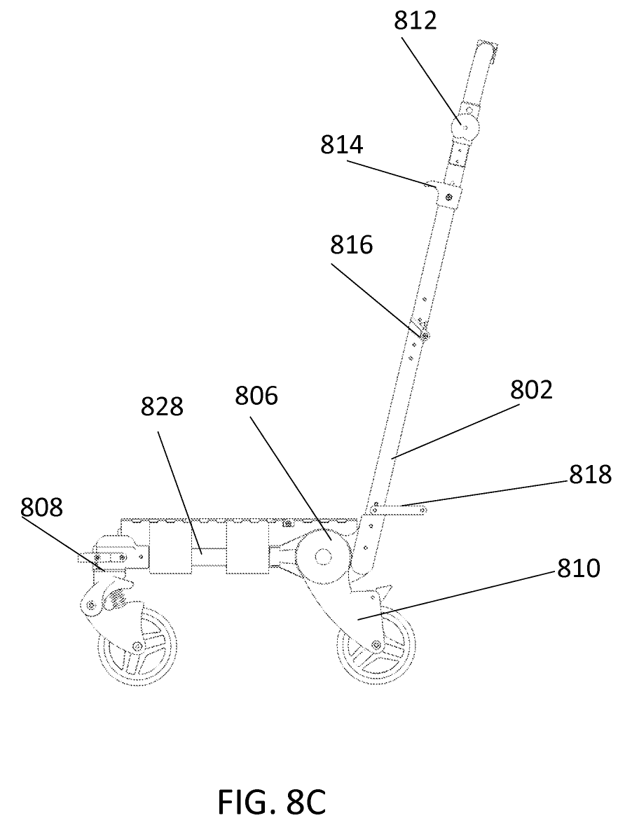

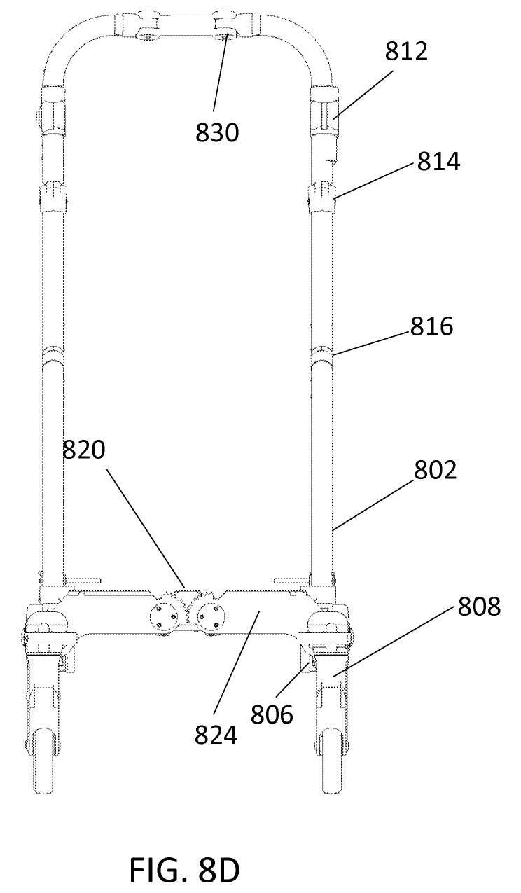

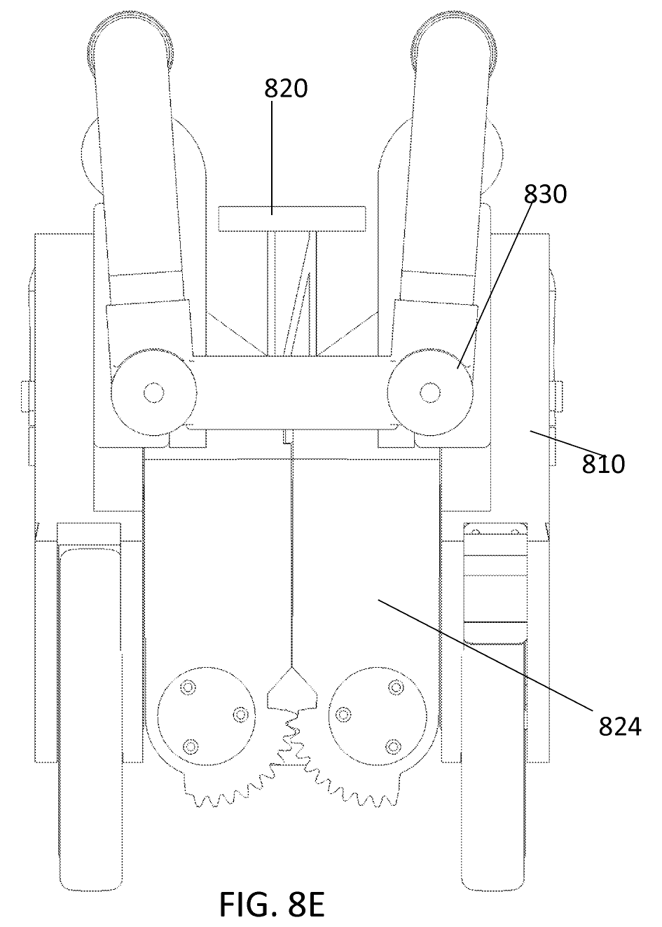

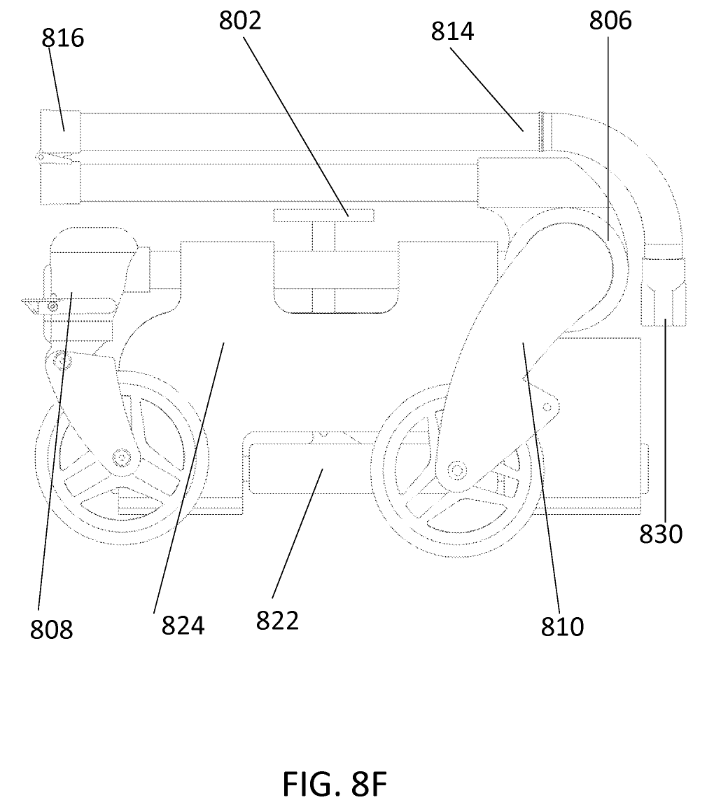

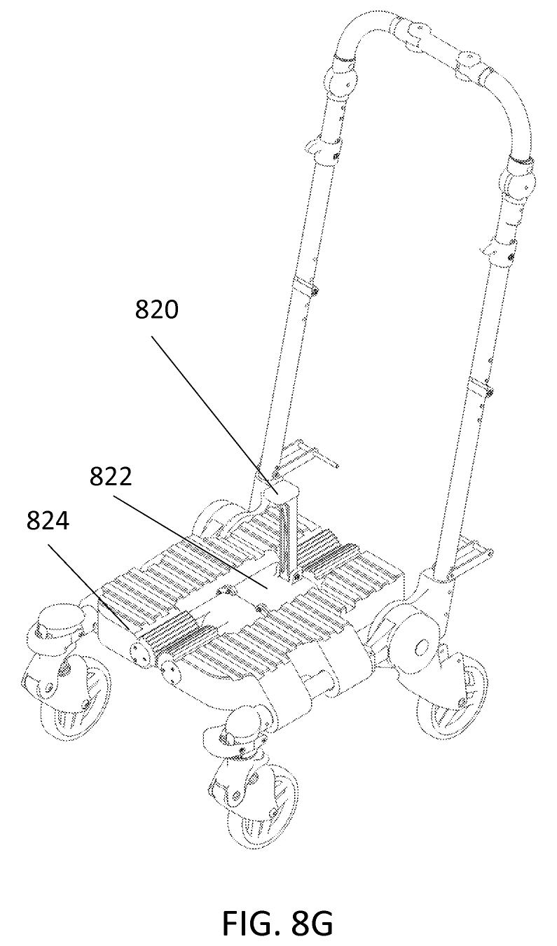

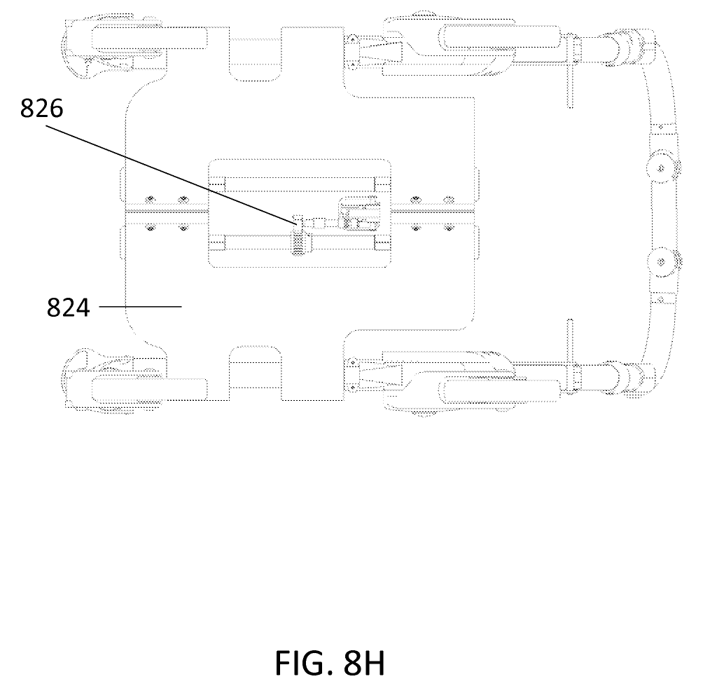

In at least one aspect of the present disclosure, a modular stroller system is disclosed. For example, and without limitation, as shown in FIG. 8A, the modular stroller system 800 includes a main handle assembly 802, a base assembly 804, a handle-to-rear-leg synchronization assembly 806, a front wheel assembly 808, and a rear wheel assembly 810. The modular stroller system 800 is a foldable structural unit designed to provide a stable support platform for an infant car seat while allowing transformation into a compact configuration for transport or storage. The main handle assembly 802 extends upward and rearward from the base assembly 804 and serves as a control and support element for pushing and maneuvering the modular stroller system 800.

In at least one aspect of the present disclosure, the base assembly 804 forms the structural core of the modular stroller system 800. The base assembly 804 includes a central block assembly 822, two lateral sub-blocks 824, a folding mechanism 826, and an auxiliary handle 820. The central block assembly 822 serves as the main structural hub that remains aligned parallel to the ground plane of the modular stroller system 800. The central block assembly 822 is connected to the two lateral sub-blocks 824. For example, and without limitation, the central block assembly 822 may be pivotably connected to the two lateral sub-blocks 824. In the deployed configuration, the lateral sub-blocks 824 are connected through the central block assembly 822 and the folding mechanism 826, forming a continuous surface. In the folded configuration, the lateral sub-blocks 824 fold inward into a compact arrangement, with the central block assembly 822 acting as a hinge axis such that the base assembly 804 folds like a book.

In at least one aspect of the present disclosure, the folding mechanism 826 is disposed within the central block assembly 822 and controls the folding and locking of the modular stroller system 800. The folding mechanism 826 is configured to selectively lock the lateral sub-blocks 824 in the deployed configuration, ensuring overall rigidity of the frame during operation, and to release the lateral sub-blocks 824 to permit folding. The folding mechanism 826 may include one or more of cam-latch assemblies, spring-loaded locking pins, or gear-based locking elements that engage corresponding features on the lateral sub-blocks 824 to prevent pivoting in the locked state.

In at least one aspect of the present disclosure, as shown in FIG. 8B, the base assembly 804 is presented from a top view in the deployed configuration. The central block assembly 822 is positioned centrally, with the two lateral sub-blocks 824 disposed on either side of the central block assembly 822. The lateral sub-blocks 824 form a continuous planar support surface substantially parallel to a ground plane in the deployed configuration. The boundary between the central block assembly 822 and each lateral sub-block 824 defines a pivot axis for the book-fold mechanism. The auxiliary handle 820 may be retractably stored within the central block assembly 822 and may be visible in a retracted position from the top view.

In at least one aspect of the present disclosure, tubular transition elements 828 connect the base assembly 804 to the front wheel assembly 808 and the rear wheel assembly 810. The tubular transition elements 828 transfer load between the central block assembly 822 and the wheel assemblies, ensuring overall rigidity of the structure in the deployed configuration. The tubular transition elements 828 may be formed from aluminum alloy tubing and may be fixedly attached to the central block assembly 822 at one end and to the respective wheel assembly at the other end.

In at least one aspect of the present disclosure, frame anchoring elements 818 are mounted on the frame of the modular stroller system 800. Each frame anchoring element 818 can be independently locked in either a folded position or a deployed position. When deployed, the frame anchoring elements 818 provide attachment points, enabling secure attachment of an infant car seat to the modular stroller system 800. Each frame anchoring element 818 may include a bracket or bar that pivots between the folded and deployed positions and a locking mechanism, such as a detent or spring-loaded catch, that retains the frame anchoring element 818 in the selected position.

In at least one aspect of the present disclosure, as shown in FIG. 8C, the modular stroller system 800 is illustrated from a side view. The side view illustrates the spatial relationship between the main handle assembly 802, the base assembly 804, the front wheel assembly 808, and the rear wheel assembly 810. The main handle assembly 802 extends upward and rearward from the base assembly 804. The front wheel assembly 808 is positioned at the front-lower portion of the modular stroller system 800, and the rear wheel assembly 810 is positioned at the rear-lower portion.

In at least one aspect of the present disclosure, the main handle assembly 802 includes several articulated sections. The main handle assembly 802 includes a hinge joint 816 allowing the main handle assembly 802 to fold in half. The main handle assembly 802 further includes a telescopic adjustment unit 814 for reach regulation. The main handle assembly 802 may further include an angular and rotational adjustment component 812 for the terminal handle section. The main handle assembly 802 may further include paired hinge joints that allow the two branches of the main handle assembly 802 to vary their spacing during folding and unfolding. A distance adjustment component 830 may be positioned adjacent to the angular and rotational adjustment component 812, providing spacing regulation between the paired branches of the main handle assembly 802.

In at least one aspect of the present disclosure, the handle-to-rear-leg synchronization assembly 806 provides the kinematic coupling between the main handle assembly 802 and the rear wheel assembly 810. The handle-to-rear-leg synchronization assembly 806 is operatively coupled to the rear wheel assembly 810 and the main handle assembly 802. When the main handle assembly 802 is folded downward, the handle-to-rear-leg synchronization assembly 806 transmits this motion to a rear wheel strut of the rear wheel assembly 810, causing the rear wheel strut to retract into a compact position. The handle-to-rear-leg synchronization assembly 806 may include pivot joints and connecting links disposed at the rear wheel assembly 810 that translate the rotational motion of the main handle assembly 802 into the retraction of the rear wheel strut.

In at least one aspect of the present disclosure, the rear wheel assembly 810 incorporates a folding linkage connected to a rear wheel strut, allowing the rear wheel strut to retract into a compact position during folding. The rear wheel strut is pivotably connected via the folding linkage, and the rear wheel strut is retractable into a compact position during folding. The folding linkage provides the kinematic connection between the rear wheel and the main handle assembly 802 through the handle-to-rear-leg synchronization assembly 806.

In at least one aspect of the present disclosure, as shown in FIG. 8D, the modular stroller system 800 is presented from a front view. The front view illustrates the front wheel assembly 808 positioned at the bottom-center of the modular stroller system 800. The front wheel assembly 808 allows directional movement of the modular stroller system 800. The front wheel assembly 808 may include an integrated locking mechanism configured to prevent wheel swiveling when engaged. The locking mechanism may be a swivel-lock actuated by a lever or button on the wheel housing, which, when engaged, prevents the front wheel from swiveling and constrains the modular stroller system 800 to straight-line travel.

In at least one aspect of the present disclosure, the front view of FIG. 8D illustrates the lateral sub-blocks 824 as distinct left and right halves of the base assembly 804. The central block assembly 822 is positioned centrally between the lateral sub-blocks 824. The main handle assembly 802 branches extend upward from the base assembly 804, with the two branches visible in the front view.

In at least one aspect of the present disclosure, as shown in FIGS. 8E and 8F, the modular stroller system 800 is presented in a fully folded configuration. FIG. 8E illustrates a rear view of the modular stroller system 800 in the fully folded configuration, and FIG. 8F illustrates a side view of the modular stroller system 800 in the fully folded configuration. In the fully folded configuration, the base assembly 804 is in a folded state with the lateral sub-blocks 824 folded inward toward each other about the central block assembly 822, such that the base assembly 804 is folded like a closed book.

In at least one aspect of the present disclosure, in the fully folded position, the main handle assembly 802 is folded downward and folded in half at the hinge joint 816. The folding of the main handle assembly 802 downward causes retraction of the rear wheel strut through the handle-to-rear-leg synchronization assembly 806. The rear wheel strut of the rear wheel assembly 810 is in a retracted position in the fully folded configuration.

In at least one aspect of the present disclosure, the fully folded configuration achieves a compact volume for transport or storage. The folding sequence includes operating the auxiliary handle 820 to release the folding mechanism 826, thereby causing the lateral sub-blocks 824 to fold inward toward each other about the central block assembly 822. The folding sequence further includes folding the main handle assembly 802 downward, which causes retraction of the rear wheel strut through the handle-to-rear-leg synchronization assembly 806. The folding sequence further includes folding the main handle assembly 802 in half through the hinge joint 816.

In at least one aspect of the present disclosure, as shown in FIG. 8G, the modular stroller system 800 is presented in the deployed configuration with the auxiliary handle 820 in an extended operating position. FIG. 8G illustrates a similar viewing angle to FIG. 8A, with the auxiliary handle 820 visibly extended from the central block assembly 822 into its operating position. The auxiliary handle 820 is retractably stored within the base assembly 804, integrated into the central block assembly 822.

In at least one aspect of the present disclosure, the auxiliary handle 820 is operatively coupled to the folding mechanism 826 to transition the base assembly 804 between the deployed configuration and the folded configuration. Operating the auxiliary handle 820 allows a user to engage and switch the folding mechanism 826 between folding and unfolding modes. The auxiliary handle 820 is configured for initiating the folding and unfolding of the base assembly 804. The main handle assembly 802 does not actuate the base assembly 804 folding system.

In at least one aspect of the present disclosure, when the auxiliary handle 820 is in the retracted position, the auxiliary handle 820 is stored within the central block assembly 822 and may not be prominently visible. When the auxiliary handle 820 is in the extended operating position, the auxiliary handle 820 emerges from the central block assembly 822 and is accessible to the user for initiating the folding sequence.

In at least one aspect of the present disclosure, as shown in FIG. 8H, the modular stroller system 800 is presented from a bottom view. The bottom view reveals the underside of the base assembly 804, showing the arrangement of the folding mechanism 826 and the pivot connections between the central block assembly 822 and the lateral sub-blocks 824. The folding mechanism 826 is disposed within the central block assembly 822 and is visible from the bottom view.

In at least one aspect of the present disclosure, the folding mechanism 826 is configured to mechanically engage the lateral sub-blocks 824 to lock the lateral sub-blocks 824 in the deployed configuration. The pivot connections between the central block assembly 822 and the lateral sub-blocks 824 define the book-fold axes about which the lateral sub-blocks 824 pivot during folding and unfolding. The pivot connections may include hinge elements disposed along the longitudinal edges of the central block assembly 822.

In at least one aspect of the present disclosure, the bottom view of FIG. 8H illustrates the frame anchoring elements 818 and their mounting locations on the frame of the modular stroller system 800. The frame anchoring elements 818 are shown in the deployed position, providing attachment points for securing an infant car seat. Each frame anchoring element 818 may be lockable in each of the deployed position and the folded position.

In at least one aspect of the present disclosure, in the deployed configuration, the modular stroller system 800 provides a stable support platform for mounting and supporting an infant car seat. The lateral sub-blocks 824 are securely held by the folding mechanism 826, ensuring overall rigidity of the frame during operation. The deployed structure forms a support platform configured to mount and support an infant car seat.

In at least one aspect of the present disclosure, the support platform is structurally supported by the tubular transition elements 828 and the front and rear wheel assemblies 808, 810. The tubular transition elements 828 transfer load between the central block assembly 822 and the wheel assemblies, providing a structural load path that ensures stability of the modular stroller system 800 in the deployed configuration.

In at least one aspect of the present disclosure, when the frame anchoring elements 818 are in the deployed position, the frame anchoring elements 818 provide attachment points for securing an infant car seat to the modular stroller system 800. The frame anchoring elements 818 are independently foldable between the deployed position and the folded position, and the folding of the frame anchoring elements 818 does not impede the folding of the base assembly 804 or the main handle assembly 802.

The corresponding structures, materials, acts, and equivalents of all means or step plus function elements in the claims below are intended to include any structure, material, or act for performing the function in combination with other claimed elements as specifically claimed. The description of the present disclosure has been presented for purposes of illustration and description, but is not intended to be exhaustive or limited to the disclosure in the form disclosed. Many modifications and variations will be apparent to those of ordinary skill in the art without departing from the scope and spirit of the disclosure. The embodiment was chosen and described in order to best explain the principles of the disclosure and the practical application, and to enable others of ordinary skill in the art to understand the disclosure for various embodiments with various modifications as are suited to the particular use contemplated.

The descriptions of the various embodiments of the present disclosure have been presented for purposes of illustration but are not intended to be exhaustive or limited to the embodiments disclosed. Many modifications and variations will be apparent to those of ordinary skill in the art without departing from the scope and spirit of the described embodiments. The terminology used herein was chosen to best explain the principles of the embodiments, the practical application or technical improvement over technologies found in the marketplace, or to enable others of ordinary skill in the art to understand the embodiments disclosed herein.

What is claimed is:

1. A modular stroller system comprising:
a base assembly comprising a central block assembly and two lateral sub-blocks, wherein the two lateral sub-blocks are pivotably connected to the central block assembly, wherein the base assembly is configured to move between a folded configuration and a deployed configuration, wherein, when the base assembly moves from the deployed configuration to the folded configuration, the lateral sub-blocks are configured to fold inward toward each other about the central block assembly;
a folding mechanism disposed within the central block assembly, wherein the folding mechanism is configured to selectively lock the two lateral sub-blocks in the deployed configuration, wherein the folding mechanism is further configured to release the lateral sub-blocks to permit folding;
an auxiliary handle, wherein the auxiliary handle is operatively coupled to the folding mechanism to transition the base assembly between the deployed configuration and the folded configuration;
a main handle assembly pivotably connected to the base assembly;
a front wheel assembly connected to the base assembly;
a rear wheel assembly connected to the base assembly; and
at least one frame anchoring element mounted on the base assembly, wherein the at least one frame anchoring element is independently foldable between a deployed position and a folded position, wherein, in the deployed position, the at least one frame anchoring element is configured to provide an attachment point for an infant car seat.

2. The modular stroller system of claim 1, further comprising a handle-to-rear-leg synchronization assembly, wherein the handle-to-rear-leg synchronization assembly is configured to operatively couple folding of the main handle assembly with folding of a rear wheel strut of the rear wheel assembly.

3. The modular stroller system of claim 1, wherein, when in the deployed configuration, the two lateral sub-blocks form a continuous planar support surface substantially parallel to a ground plane, wherein the continuous planar support surface is configured to receive an infant car seat.

4. The modular stroller system of claim 1, wherein the auxiliary handle is retractably stored within the central block assembly.

5. The modular stroller system of claim 1, wherein the main handle assembly further comprises an angular and rotational adjustment component for a terminal handle section.

6. The modular stroller system of claim 1, wherein the main handle assembly comprises at least two handle branches and at least two hinge joints, wherein the at least two hinge joints are configured to control spacing between the at least two handle branches when moving between a folded position and a deployed position.

7. The modular stroller system of claim 1, wherein the rear wheel assembly comprises a rear wheel strut pivotably connected via a folding linkage, wherein the rear wheel strut is configured to retract into a compact position during folding.

8. The modular stroller system of claim 1, wherein the front wheel assembly comprises a locking mechanism, wherein, when the locking mechanism is engaged, the locking mechanism is configured to prevent wheel swiveling.

9. The modular stroller system of claim 1, wherein the main handle assembly comprises a hinge joint configured to allow the main handle assembly to fold in half.

10. The modular stroller system of claim 1, wherein the main handle assembly comprises a telescopic adjustment unit.

11. The modular stroller system of claim 1, wherein the front wheel assembly and the rear wheel assembly are connected to the base assembly via tubular transition elements.

12. The modular stroller system of claim 1, wherein each frame anchoring element is lockable in each of the deployed position and the folded position.

13. The modular stroller system of claim 1, wherein the central block assembly defines a hinge axis, wherein the hinge axis is positioned between the two lateral sub-blocks, wherein the lateral sub-blocks are configured to pivot about the hinge axis, wherein the lateral sub-blocks are configured to pivot into a closed-book configuration in the folded configuration.

14. A modular stroller system comprising:
a base assembly;
an auxiliary handle;
a main handle assembly;
a front wheel assembly; and
a rear wheel assembly;
wherein the base assembly comprises a central block assembly and two lateral sub-blocks pivotably connected to the central block assembly, the base assembly configured to transition between a deployed configuration and a folded configuration;
wherein the auxiliary handle is operatively coupled to the base assembly to initiate transition between the deployed configuration and the folded configuration;
wherein the main handle assembly is pivotably connected to the base assembly and configured to fold;
wherein the front wheel assembly is connected to the base assembly; and
wherein the rear wheel assembly is connected to the base assembly.

15. The modular stroller system of claim 14, further comprising a folding mechanism disposed within the central block assembly, the folding mechanism configured to selectively lock the two lateral sub-blocks in the deployed configuration, wherein the folding mechanism is further configured to release the lateral sub-blocks to permit folding.

16. The modular stroller system of claim 14, wherein the auxiliary handle is retractably stored within the central block assembly.

17. The modular stroller system of claim 14, further comprising at least one frame anchoring element mounted on the base assembly, the at least one frame anchoring element independently foldable between a deployed position and a folded position, wherein, in the deployed position, the at least one frame anchoring element is configured to provide an attachment point for an infant car seat.

18. The modular stroller system of claim 14, further comprising a handle-to-rear-leg synchronization assembly kinematically linking folding of the main handle assembly to retraction of a rear wheel strut of the rear wheel assembly.

19. The modular stroller system of claim 14, wherein, when the base assembly is moving from the deployed configuration to the folded configuration, the two lateral sub-blocks are configured to fold toward each other about the central block assembly.

20. The modular stroller system of claim 14, wherein the main handle assembly comprises a hinge joint, wherein the main handle assembly is configured to fold about the hinge joint.
